(19) United States
(12) Patent Application Publication
(10) Pub. No.: US 2020/0377795 A1
(43) Pub. Date: Dec. 3, 2020

(54) LIQUID CRYSTAL DISPLAY DEVICE AND METHOD FOR PRODUCING LIQUID CRYSTAL DISPLAY DEVICE

(71) Applicant: SHARP KABUSHIKI KAISHA, Sakai City, Osaka (JP)

(72) Inventors: MASANOBU MIZUSAKI, Sakai City, Osaka (JP); HIROSHI TSUCHIYA, Sakai City, Osaka (JP)

(21) Appl. No.: 16/636,781

(22) PCT Filed: Aug. 3, 2018
(86) PCT No.: PCT/JP2018/029155

§ 371 Date: Feb. 5, 2020

(30) Foreign Application Priority Data
Aug. 10, 2017 (JP) 2017-155526

(51) Int. Cl. C09K 19/20; C09K 19/30; C09K 19/52

(52) U.S. Cl. CPC C09K 19/2007; C09K 19/3068; C09K 19/52; C09K 2019/2035; C09K 2019/0448; C09K 2019/521; C09K 2323/057; C09K 2323/06; C09K 2323/02; C09K 2019/3075

(57) ABSTRACT

The present invention provides a liquid crystal display device whose liquid crystal layer is prevented from undergoing a phase transition while the device is on. A liquid crystal display device according to the present invention includes a first substrate having a thin-film transistor element, a heatsink film overlapping the thin-film transistor element, a first alignment film, a liquid crystal layer, and a second substrate in order. The heatsink film contains a liquid-crystalline polymer as the polymerized form of a liquid-crystalline monomer and also contains inorganic fine particles, and the liquid-crystalline polymer is aligned in-plane with respect to the heatsink film. Preferably, the liquid-crystalline monomer is represented by a specified chemical formula.

### TECHNICAL FIELD

The present invention relates to a liquid crystal display device and a method for producing a liquid crystal display device. To be more specific, the present invention is one relating to a liquid crystal display device having a thin-film transistor element and a method for producing this liquid crystal display device.

### BACKGROUND ART

When electronic equipment is operated, semiconductor elements therein can heat up to too high temperatures. To prevent this, researchers have been investigating how to dissipate heat produced by semiconductor elements out of electronic equipment (e.g., see PTL 1).

### CITATION LIST

### Patent Literature

PTL 1: International Publication No. 2015/170744

### SUMMARY OF INVENTION

### Technical Problem

In recent years, there is a need for quick-response liquid crystal display devices in applications such as TVs and automotive navigation systems. Examples of attempts that have been made include reducing the (absolute) dielectric anisotropy of the liquid crystal material or lowering the nematic-isotropic phase transition temperature of the liquid crystal material forming the liquid crystal layer. However, for liquid crystal display devices having thin-film transistor elements, reducing the (absolute) dielectric anisotropy of the liquid crystal material leads to a high driving voltage, thereby placing a high load on the thin-film transistor elements. This approach has therefore caused the thin-film transistor elements to produce much heat. Since the heat produced by the thin-film transistor elements increases the temperature in the region of the liquid crystal layer near the thin-film transistor elements, applying this approach to a liquid crystal material having a low nematic-isotropic phase transition temperature has caused the liquid crystal layer to readily transform from a nematic to an isotropic phase while the device is on. FFS (Fringe Field Switching) and other homogeneous alignment liquid crystal display devices, moreover, are sometimes made with low-resistance alignment films in order to reduce flickers. Such alignment films have provided a pathway for heat produced by the thin-film transistor elements to spread readily to the liquid crystal layer therethrough.

To address this, the inventors investigated placing a thermal insulating film between the thin-film transistor elements and the liquid crystal layer with the aim of preventing heat produced by the thin-film transistor elements from spreading to the liquid crystal layer. Placing a thermal insulating film between the thin-film transistor elements and the liquid crystal element, however, means blocking the escape of heat produced by the thin-film transistor elements. The temperature of the thin-film transistor elements therefore occasionally became so high as to change their characteristics (mobility, off-leakage current, etc.).

Overall, a problem with known liquid crystal display devices is the prevention of the liquid crystal layer from undergoing a phase transition while the device is on. Solutions to this problem, however, remained to be found. For example, PTL 1 above provides no specific methodology for how to apply a heatsink to a liquid crystal display device; there is room for improvement in it.

The present invention was made in view of these current circumstances and is aimed at providing a liquid crystal display device whose liquid crystal layer is prevented from undergoing a phase transition while the device is on, and also providing a method for producing this liquid crystal display device.

### Solution to Problem

After extensive research to develop a liquid crystal display device whose liquid crystal layer is prevented from undergoing a phase transition while the device is on and a method for producing such a liquid crystal display device, the inventors focused on using a heatsink film that conducts heat produced by the thin-film transistor elements in the in-plane direction. It was then found that with such a heatsink film, it is less likely that the spread of heat produced by the thin-film transistor elements is limited to the region of the liquid crystal layer near the thin-film transistor elements, and therefore local temperature elevation in portions of the liquid crystal layer is less likely. The inventors conceived that this would be a fine solution to the above problem, and have arrived at the present invention.

That is, an aspect of the present invention may be a liquid crystal display device that includes a first substrate having a thin-film transistor element, a heatsink film overlapping the thin-film transistor element, a first alignment film, a liquid crystal layer, and a second substrate in order. The heatsink film contains at least one liquid-crystalline polymer as the polymerized form of at least one liquid-crystalline monomer and also contains inorganic fine particles, and the liquid-crystalline polymer is aligned in-plane with respect to the heatsink film.

In an aspect of the present invention, there may be a heatsink-film alignment film, a film that controls the orientation of the liquid-crystalline polymer, between the first substrate and the heatsink film.

In an aspect of the present invention, the liquid-crystalline monomer may be represented by chemical formula (1) below.

P¹-Sp¹-R¹-A¹-(Z¹-A²)ₙ-R² (1)

(In chemical formula (1) above, R² represents an —R³-Sp²-P² group, hydrogen atom, halogen atom, —CN group, —NO₂ group, —NCO group, —NCS group, —OCN group, —SCN group, —SF; group, or linear or branched C1 to C18 alkyl group. P¹ and P² may be the same or different and each represent an acryloyloxy group or methacryloyloxy group. Sp¹ and Sp² may be the same or different and each represent a linear, branched, or cyclic C1 to C6 alkylene group, linear, branched, or cyclic C1 to C6 alkyleneoxy group, or direct bond. R¹ and R³ may be the same or different and each represent an —O— group, —S— group, —NH— group, —CO— group, —COO— group, —OCO— group, or direct bond. A¹ and A² may be the same or different and each represent a 1,4-phenylene group, naphthalen-2,6-diyl group, or 1,4-cyclohexylene group. The hydrogen atoms A¹ and A² have may be substituted with a fluorine atom, chlorine atom, —CN group, or C1 to C6 alkyl group, alkoxy group, alkylcarbonyl group, alkoxycarbonyl group, or alkylcarbonyloxy group. Z¹ represents an —O— group, —S— group, —NH— group, —CO— group, —COO— group, —OCO— group, or direct bond. n represents 0, 1, 2, or 3.)

In an aspect of the present invention, the liquid-crystalline monomer may include at least one of the monomers represented by chemical formulae (2) and (3) below.

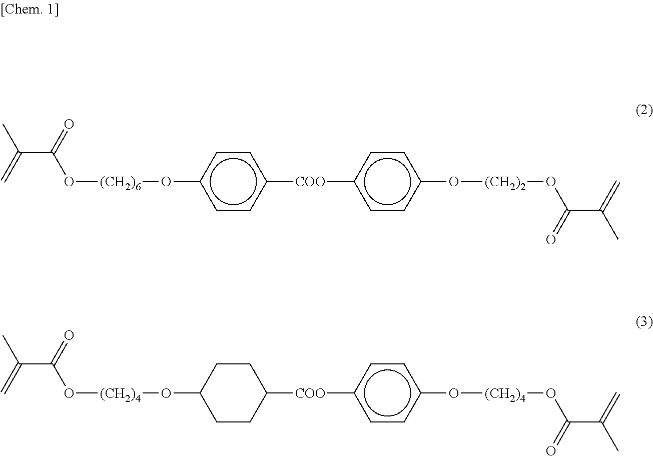

In an aspect of the present invention, the inorganic fine particles may be at least one nitride.

In an aspect of the present invention, the nitride may include at least one compound selected from the group consisting of boron nitride, silicon nitride, and aluminum nitride.

In an aspect of the present invention, the absolute dielectric anisotropy of the liquid crystal material forming the liquid crystal layer may be 3.0 or less.

In an aspect of the present invention, the electrical resistance of the first alignment film may be 1×10¹⁴ Ω·cm or less.

In an aspect of the present invention, the percentage by weight of the inorganic fine particles to the liquid-crystalline monomer may be 10% by weight or more.

In an aspect of the present invention, the first alignment film may be a photoalignment film, an alignment film having at least one photoreactive functional group.

In an aspect of the present invention, the photoreactive functional group may include at least one of the azobenzene group and the cinnamate group.

Another aspect of the present invention may be a method for producing a liquid crystal display device that includes a first substrate having a thin-film transistor element, a liquid crystal layer, and a second substrate in order. The method includes step (1) as a step of applying a liquid-crystalline composition containing at least one liquid-crystalline monomer and inorganic fine particles to the surface of the first substrate, step (2) as a step of exposing the liquid-crystalline composition to light to polymerize the liquid-crystalline monomer and thereby to form a heatsink film overlapping the thin-film transistor element, and step (3) as a step of forming a first alignment film on the surface of the heatsink film. The heatsink film contains at least one liquid-crystalline polymer as the polymerized form of the liquid-crystalline monomer and also contains the inorganic fine particles, and the liquid-crystalline polymer is aligned in-plane with respect to the heatsink film.

In another aspect of the present invention, the method for producing a liquid crystal display device may further include, between steps (2) and (3), step (4) as a step of rubbing the surface of the heatsink film.

In another aspect of the present invention, the method for producing a liquid crystal display device may further include, before step (1), step (5) as a step of forming a heatsink-film alignment film, a film that controls the orientation of the liquid-crystalline polymer, on the surface of the first substrate.

In another aspect of the present invention, radical polymerization or condensation polymerization of the liquid-crystalline monomer may be performed in step (2).

In another aspect of the present invention, the liquid-crystalline monomer may be represented by chemical formula (1) below.

P¹-Sp¹-R¹-A¹-(Z¹-A²)ₙ-R² (1)

(In chemical formula (1) above, R² represents an —R³-Sp²-P² group, hydrogen atom, halogen atom, —CN group, —NO₂ group, —NCO group, —NCS group, —OCN group, —SCN group, —SF₆ group, or linear or branched C1 to C18 alkyl group. P¹ and P² may be the same or different and each represent an acryloyloxy group or methacryloyloxy group. Sp¹ and Sp² may be the same or different and each represent a linear, branched, or cyclic C1 to C6 alkylene group, linear, branched, or cyclic C1 to C6 alkyleneoxy group, or direct bond. R¹ and R³ may be the same or different and each represent an —O— group, —S— group, —NH— group, —CO— group, —COO— group, —OCO— group, or direct bond. A¹ and A² may be the same or different and each represent a 1,4-phenylene group, naphthalen-2,6-diyl group, or 1,4-cyclohexylene group. The hydrogen atoms A¹ and A² have may be substituted with a fluorine atom, chlorine atom, —CN group, or C1 to C6 alkyl group, alkoxy group, alkylcarbonyl group, alkoxycarbonyl group, or alkylcarbonyloxy group. Z=represents an —O— group, —S— group, —NH— group, —CO— group, —COO— group, —OCO— group, or direct bond. n represents 0, 1, 2, or 3.)

In another aspect of the present invention, the liquid-crystalline monomer may include at least one of the monomers represented by chemical formulae (2) and (3) below.

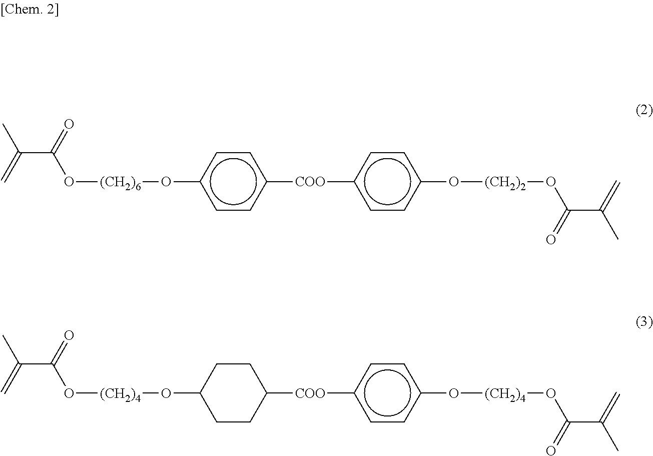

In another aspect of the present invention, the inorganic fine particles may be at least one nitride.

In another aspect of the present invention, the nitride may include at least one compound selected from the group consisting of boron nitride, silicon nitride, and aluminum nitride.

In another aspect of the present invention, the absolute dielectric anisotropy of the liquid crystal material forming the liquid crystal layer may be 3.0 or less.

In another aspect of the present invention, the electrical resistance of the first alignment film may be 1×10¹⁴ Ω·cm or less.

In another aspect of the present invention, the percentage by weight of the inorganic fine particles to the liquid-crystalline monomer may be 10% by weight or more.

In another aspect of the present invention, the first alignment film may be a photoalignment film, an alignment film having at least one photoreactive functional group.

In another aspect of the present invention, the photoreactive functional group may include at least one of the azobenzene group and the cinnamate group.

### Advantageous Effects of Invention

According to the present invention, it is possible to provide a liquid crystal display device whose liquid crystal layer is prevented from undergoing a phase transition while the device is on and to provide a method for producing this liquid crystal display device.

### BRIEF DESCRIPTION OF DRAWINGS

FIG. 1 is a cross-sectional schematic diagram illustrating a liquid crystal display device according to Embodiment 1.

FIG. 2 is a cross-sectional schematic diagram illustrating Configuration 1 of the first substrate in FIG. 1.

FIG. 3 is a cross-sectional schematic diagram illustrating Configuration 2 of the first substrate in FIG. 1.

FIG. 4 includes cross-sectional schematic diagrams for describing a method for producing a liquid crystal display device according to Embodiment 1.

FIG. 5 is a cross-sectional schematic diagram illustrating a liquid crystal display device according to Embodiment 2.

FIG. 6 is a cross-sectional schematic diagram illustrating Configuration 1 of the first substrate in FIG. 5.

FIG. 7 is a cross-sectional schematic diagram illustrating Configuration 2 of the first substrate in FIG. 5.

FIG. 8 includes cross-sectional schematic diagrams for describing a method for producing a liquid crystal display device according to Embodiment 2.

### DESCRIPTION OF EMBODIMENTS

The following describes the present invention in further detail by providing embodiments and with reference to drawings. The present invention, however, is not limited to these embodiments. The configurations in each embodiment may optionally be combined or changed within the scope of the present invention.

As used herein, “between values X and Y” means “X or more and Y or less.”

### Embodiment 1

The following describes a liquid crystal display device according to Embodiment 1 and a method for producing it.

### (1) Liquid Crystal Display Device

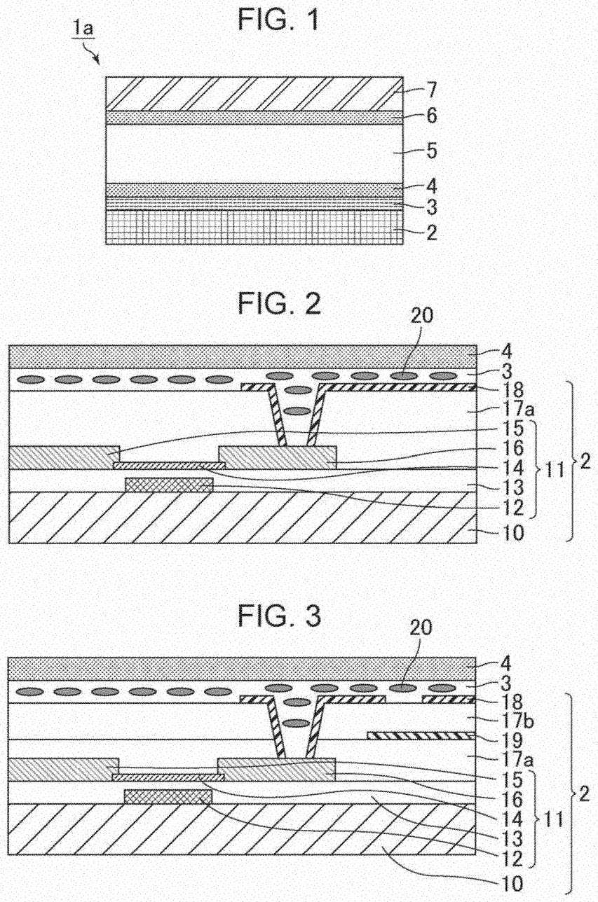

The following describes a liquid crystal display device according to Embodiment 1 with reference to FIG. 1. FIG. 1 is a cross-sectional schematic diagram illustrating a liquid crystal display device according to Embodiment 1.

The liquid crystal display device 1a has a first substrate 2, a heatsink film 3, a first alignment film 4, a liquid crystal layer 5, a second alignment film 6, and a second substrate 7 in order. The first and second substrates 2 and 7 are opposite each other and have been joined together with a sealant (not illustrated) with the liquid crystal layer 5 sandwiched therebetween.

### <Second Substrate>

The second substrate 7 may be a color-filter substrate. An example of a configuration of a color-filter substrate is one composed of a support substrate and a color-filter layer, black matrix, or similar material on the surface of the support substrate.

Examples of materials for the support substrate include glass and plastics.

An example of a material for a color-filter layer is a color resist with a dispersed pigment therein. The combination of colors in the color-filter layer is not critical, and examples include the combination of red, green, and blue and the combination of red, green, blue, and yellow.

An example of a material for a black matrix is a black resist.

Depending on the display mode of the liquid crystal display device 1a, the second substrate 7 may further have an electrode. This electrode may be disposed to, for example, cover the black matrix.

### <Second Alignment Film>

On the surface of the second substrate 7 closer to the liquid crystal layer 5, there may be a second alignment film 6 as illustrated in FIG. 1. The second alignment film 6 functions as a film capable of controlling the orientation of liquid crystal molecules in the liquid crystal material forming the liquid crystal layer 5. The second alignment film 6 may be a film (whether single-layer or multilayer) formed by at least one compound selected from the group consisting of polyimides, polyamic acids, polymaleimides, polyamides, polysiloxanes, polyphosphazenes, polysilsesquioxanes, and copolymers thereof or an obliquely deposited film of a silicon oxide. The surface of the second alignment film 6 may have been treated for alignment, for example by photoalignment or rubbing.

### <First Substrate>

The following describes examples of configurations of the first substrate 2 with reference to FIGS. 2 and 3.

### (Configuration 1)

FIG. 2 is a cross-sectional schematic diagram illustrating Configuration 1 of the first substrate in FIG. 1. The first substrate 2 illustrated by way of example in FIG. 2 is a thin-film transistor array substrate for use in liquid crystal display devices such as IPS (In-Plane Switching), UV²A (Ultra-violet induced Multi-domain Vertical Alignment), MVA (Multi-domain Vertical Alignment), or TN (Twisted Nematic) ones. To help the reader understand the relationship with FIG. 1, FIG. 2 also includes the heatsink film 3 and the first alignment film 4.

As illustrated in FIG. 2, the first substrate 2 has a support substrate 10, thin-film transistor elements 11, an interlayer insulating film 17a, and pixel electrodes 18.

A thin-film transistor element 11 has a gate electrode 12, a gate insulating film 13, a semiconductor layer 14, a source electrode 15, and a drain electrode 16. The gate electrode 12 is on the surface of the support substrate 10 and is covered by the gate insulating film 13. The semiconductor layer 14 is on the surface of the gate insulating film 13 opposite the support substrate 10. One end of the semiconductor layer 14 is covered by and electrically coupled to the source electrode 15, and the other is covered by and electrically coupled to the drain electrode 16.

The interlayer insulating film 17a covers the thin-film transistor elements 11, and part of the film has openings.

The pixel electrodes 18 are on the surface of the interlayer insulating film 17a opposite the support substrate 10 and are electrically coupled to the drain electrodes 16 via the openings in the interlayer insulating film 17a.

### (Configuration 2)

FIG. 3 is a cross-sectional diagram illustrating Configuration 2 of the first substrate in FIG. 1. The first substrate 2 illustrated by way of example in FIG. 3 is a thin-film transistor array substrate for use in FFS liquid crystal display devices. To help the reader understand the relationship with FIG. 1, FIG. 3 also includes the heatsink film 3 and the first alignment film 4. Configuration 2 is the same as Configuration 1 except that it uses a bilayer electrode structure, so details in common with Configuration 1 may be omitted.

As illustrated in FIG. 3, the first substrate 2 has a support substrate 10, thin-film transistor elements 11, an interlayer insulating film 17a, a common electrode 19, an interlayer insulating film 17b, and pixel electrodes 18.

The common electrode 19 is on the surface of the interlayer insulating film 17a opposite the support substrate 10.

The interlayer insulating film 17b covers the common electrode 19, and part of the film has openings.

The pixel electrodes 18 are on the surface of the interlayer insulating film 17b opposite the support substrate 10 and are electrically coupled to the drain electrodes 16 via the openings in the interlayer insulating films 17a and 17b.

Examples of materials for the support substrate 10 include glass and plastics.

Examples of materials for the gate, source, and drain electrodes 12, 15, and 16 include metal materials, such as aluminum, copper, titanium, molybdenum, and chromium.

Examples of materials for the gate insulating film 13 include inorganic materials, such as silicon oxides and silicon nitrides.

Examples of materials for the semiconductor layer 14 include amorphous silicon, polycrystalline silicon, and oxide semiconductors. For low power consumption and quick driving, oxide semiconductors are particularly preferred. Oxide semiconductors enable low power consumption by virtue of their low off-leakage current (leakage current when the thin-film transistor elements 11 are in the off state) and also enable quick driving by virtue of their high on-current (current when the thin-film transistor elements 11 are in the on state). Examples of oxide semiconductors include compounds of indium, gallium, zinc, and oxygen and compounds of indium, tin, zinc, and oxygen.

Examples of materials for the interlayer insulating films 17a and 17b include organic materials, such as polyimides; and inorganic materials, such as silicon nitrides.

Examples of materials for the pixel and common electrodes 18 and 19 include transparent materials (inorganic materials), such as indium tin oxide (ITO) and indium zinc oxide (IZO).

### <Heatsink Film>

The heatsink film 3, as illustrated in FIGS. 2 and 3, overlaps the thin-film transistor elements 11 present in the first substrate 2. Preferably, the heatsink film 3 extends over an area broader than the region where the thin-film transistor elements 11 reside, more preferably over the entire surface of the first substrate 2. This makes local temperature elevation in the liquid crystal layer 5 less likely.

The heatsink film 3 is a film that contains at least one liquid-crystalline polymer as the polymerized form of at least one liquid-crystalline monomer and also contains inorganic fine particles 20. The inorganic fine particles 20 have been dispersed in the liquid-crystalline polymer.

The liquid-crystalline polymer is aligned not along the thickness of the heatsink film 3 but in-plane with respect to the heatsink film 3. The inorganic fine particles 20 are uniformly distributed along the orientation of the liquid-crystalline polymer and in consequence are uniformly distributed in-plane with respect to the heatsink film 3. Here, the inorganic fine particles 20 being uniformly distributed in-plane with respect to the heatsink film 3 means that there are an almost equal number of inorganic fine particles 20 per very small unit area. Preferably, the spacing between inorganic fine particles 20 is equal to or shorter than five times the length of the major axis of the inorganic fine particles 20 in the same plane. Overall, by virtue of the heatsink film 3, heat produced by the thin-film transistor elements 11 spreads in-plane with respect to the heatsink film 3 through the liquid-crystalline polymer and the inorganic fine particles 20. As a result, it becomes less likely that the spread of heat produced by the thin-film transistor elements 11 is limited to the region of the liquid crystal layer 5 near the thin-film transistor elements 11, and local temperature elevation in the liquid crystal layer 5 becomes less likely. The liquid crystal layer 5 is therefore prevented from undergoing a phase transition while the device is on.

Such an orientation can be given to the liquid-crystalline polymer by, for example, rubbing the surface of the heatsink film 3. Here, the liquid-crystalline polymer being aligned in-plane with respect to the heatsink film 3 means that the major axis of the liquid-crystalline polymer is inclined at an angle between 0° and 5°, preferably between 0° and 2°, with respect to the surface of the heatsink film 3 in cross-sectional view. The liquid-crystalline polymer in plan view may be aligned unidirectionally or may be oriented randomly in multiple directions, but for efficient spread of heat produced by the thin-film transistor elements 11, unidirectional alignment is preferred. For example, if the surface of the heatsink film 3 has been rubbed unidirectionally, the liquid-crystalline polymer is aligned in the direction of rubbing in plan view. The orientation of the liquid-crystalline polymer can be checked by, for example, measurement using polarized ultraviolet-visible absorption or retardation measurement.

Preferably, the liquid-crystalline monomer is represented by chemical formula (1) below.

P¹-Sp¹-R¹-A¹-(Z¹-A²)ₙ-R² (1)

(In chemical formula (1) above, R² represents an —R³-Sp²-P² group, hydrogen atom, halogen atom, —CN group, —NO₂ group, —NCO group, —NCS group, —OCN group, —SCN group, —SF; group, or linear or branched C1 to C18 alkyl group. P¹ and P² may be the same or different and each represent an acryloyloxy group or methacryloyloxy group. Sp¹ and Sp² may be the same or different and each represent a linear, branched, or cyclic C1 to C6 alkylene group, linear, branched, or cyclic C1 to C6 alkyleneoxy group, or direct bond. R¹ and R³ may be the same or different and each represent an —O— group, —S— group, —NH— group, —CO— group, —COO— group, —OCO— group, or direct bond. A¹ and A² may be the same or different and each represent a 1,4-phenylene group, naphthalen-2,6-diyl group, or 1,4-cyclohexylene group. The hydrogen atoms A¹ and A² have may be substituted with a fluorine atom, chlorine atom, —CN group, or C1 to C6 alkyl group, alkoxy group, alkylcarbonyl group, alkoxycarbonyl group, or alkylcarbonyloxy group. Z=represents an —O— group, —S— group, —NH— group, —CO— group, —COO— group, —OCO— group, or direct bond. n represents 0, 1, 2, or 3.)

If the first alignment film 4 is a polyimide-based alignment film, it is preferred that R¹ (R³) and Z: in chemical formula (1) above be —NH— groups, —CO— groups, —COO— groups, or —OCO— groups. This improves adhesion to the first alignment film 4. Preferably, at least one of A¹ and A² in chemical formula (1) above is a 1,4-phenylene group or naphthalen-2,6-diyl group. This promotes interactions with aromatic units in the first alignment film 4.

More preferably, the liquid-crystalline monomer includes at least one of the monomers represented by chemical formulae (2) and (3) below. If, for example, the first alignment film 4 is a polyimide-based alignment film, a heatsink film 3 containing the polymerized form (liquid-crystalline polymer) of such liquid-crystalline monomer(s) allows the first alignment film 4 to be placed uniformly on its surface by virtue of its high compatibility with the polyamic acid precursor of the alignment film. As a result, low contrast of the liquid crystal display device 1a is prevented.

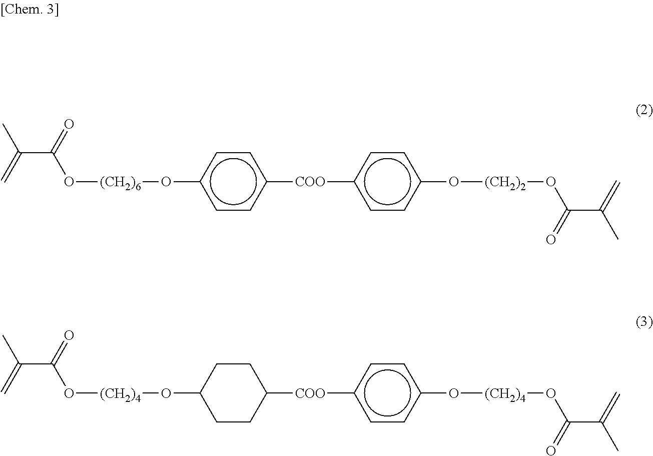

Preferably, the inorganic fine particles 20 are at least one nitride. The nitride preferably includes at least one compound selected from the group consisting of boron nitride, silicon nitride, and aluminum nitride. With such inorganic fine particles 20, heat produced by the thin-film transistor elements 11 spreads in-plane with respect to the heatsink film 3 efficiently.

Preferably, the percentage by weight of the inorganic fine particles 20 to the liquid-crystalline monomer is 10% by weight or more. If the percentage by weight of the inorganic fine particles 20 to the liquid-crystalline monomer is 10% by weight or more, heat produced by the thin-film transistor elements 11 spreads in-plane with respect to the heatsink film 3 efficiently, and the liquid crystal layer 5 is fully prevented from undergoing a phase transition while the device is on. Too high a percentage by weight of the inorganic fine particles 20 to the liquid-crystalline monomer, however, can lead to low contrast of the liquid crystal display device 1a as a result of light scattering by the inorganic fine particles 20. In light of these, the percentage by weight of the inorganic fine particles 20 to the liquid-crystalline monomer is preferably 40% by weight or less.

The thickness of the heatsink film 3 is not critical, but preferably is between 30 and 3000 nm. If the thickness of the heatsink film 3 is smaller than 30 nm, heat produced by the thin-film transistor elements 11 may spread preferentially to the region of the liquid crystal layer 5 near the thin-film transistor elements 11. If the thickness of the heatsink film 3 is larger than 3000 nm, the display characteristics (in particular, contrast) of the liquid crystal display device 1a may be affected, for example as a result of a retardation produced by the heatsink film 3.

### <First Alignment Film>

The first alignment film 4 functions as a film capable of controlling the orientation of liquid crystal molecules in the liquid crystal material forming the liquid crystal layer 5. Like the second alignment film 6, the first alignment film 4 may be a film (whether single-layer or multilayer) formed by at least one compound selected from the group consisting of polyimides, polyamic acids, polymaleimides, polyamides, polysiloxanes, polyphosphazenes, polysilsesquioxanes, and copolymers thereof or an obliquely deposited film of a silicon oxide. The surface of the first alignment film 4 may have been treated for alignment, for example by photoalignment or rubbing.

The first alignment film 4 may be a photoalignment film, an alignment film that has at least one photoreactive functional group. A photoreactive functional group is a functional group that exhibits anchoring strength, or becomes capable of controlling the orientation of liquid crystal molecules, when exposed to light. Preferably, the photoreactive functional group includes at least one of the azobenzene group and the cinnamate group. With such a first alignment film 4, the liquid crystal display device 1a achieves high contrast. The second alignment film 6, too, may be a photoalignment film as described above.

The first alignment film 4 may be a homogeneous alignment film. The function of a homogeneous alignment film is to align nearby liquid crystal molecules parallel to its surface. Here, liquid crystal molecules being aligned parallel to the surface of a homogeneous alignment film means that the pretilt angle of the liquid crystal molecules is between 0° and 5°, preferably between 0° and 2°, more preferably between 0° and 1° with respect to the surface of the homogeneous alignment film. The pretilt angle of liquid crystal molecules represents the angle at which the major axis of the liquid crystal molecules is inclined with respect to the surface of an alignment film when the voltage applied to the liquid crystal layer 5 is below the threshold voltage (including the case in which there is no applied voltage). If the display mode of the liquid crystal display device 1a is a homogeneous alignment mode (e.g., FFS or IPS), homogeneous alignment films are used. The homogeneous alignment films may be homogeneous photoalignment films, homogeneous alignment films that have a photoreactive functional group as described above. The second alignment film 6, too, may be a homogeneous alignment film (homogeneous photoalignment film) as described above.

The first alignment film 4 may be a homeotropic alignment film. The function of a homeotropic alignment film is to align nearby liquid crystal molecules perpendicular to its surface. Here, liquid crystal molecules being aligned perpendicular to the surface of a homeotropic alignment film means that the pretilt angle of the liquid crystal molecules is between 82° and 90°, preferably between 86° and 90°, more preferably between 88° and 90° with respect to the surface of the homeotropic alignment film. If the display mode of the liquid crystal display device 1a is a homeotropic alignment mode (e.g., UV²A or MVA), homeotropic alignment films are used. The homeotropic alignment films may be homeotropic photoalignment films, homeotropic alignment films that have a photoreactive functional group as described above. The second alignment film 6, too, may be a homeotropic alignment film (homeotropic photoalignment film) as described above.

The electrical resistance of the first alignment film 4 may be 1×10¹⁴ Ω·cm or less. Known liquid crystal display devices are sometimes made with low-resistance (e.g., 1×10¹⁴ Ω·cm or less) alignment films in order to reduce flickers when the FFS or other homogeneous alignment mode is used. Such alignment films have provided a pathway for heat produced by the thin-film transistor elements to spread readily to the liquid crystal layer, causing the liquid crystal layer to readily undergo a phase transition while the device is on. In this embodiment, there is a heatsink film 3 between the first substrate 2 (thin-film transistor elements 11) and the first alignment film 4, and even if the electrical resistance of the first alignment film 4 is low (e.g., 1×10¹⁴ Ω·cm or less), the heatsink film 3 will prevent the liquid crystal layer 5 from undergoing a phase transition while the device is on. The first alignment film 4 tends to have an electrical resistance of 1×10¹ Ω·cm or less when it is a photoalignment film, an alignment film that has a photoreactive functional group, or when it is a polyimide-based alignment film (particularly when the acid anhydride unit is derived from an aromatic compound). An electrical resistance of the first alignment film 4 higher than 1×10¹⁴ Ω·cm can affect the contrast of the liquid crystal display device 1a.

The thickness of the first alignment film 4 may be 120 nm or less. Known liquid crystal display devices may have thin alignment films (e.g., 120 nm or thinner), but such alignment films have provided a pathway for heat produced by the thin-film transistor elements to spread readily to the liquid crystal layer, causing the liquid crystal layer to readily undergo a phase transition while the device is on. In this embodiment, there is a heatsink film 3 between the first substrate 2 (thin-film transistor elements 11) and the first alignment film 4, and even if the thickness of the first alignment film 4 is small (e.g., 120 nm or less), the heatsink film 3 will prevent the liquid crystal layer 5 from undergoing a phase transition while the device is on.

### <Liquid Crystal Layer>

Preferably, the liquid crystal material forming the liquid crystal layer is a nematic liquid crystal material. The nematic liquid crystal material may be one that transforms from a nematic into an isotropic phase with increasing temperature. In this case, the nematic-isotropic phase transition temperature of the liquid crystal material forming the liquid crystal layer 5 may be 97° C. or lower. Known liquid crystal display devices may have a liquid crystal material having a low (e.g., 97° C. or lower) nematic-isotropic phase transition temperature with the aim of quicker response. With such a liquid crystal material, however, the liquid crystal layer has tended to undergo a phase transition in the region near the thin-film transistor elements while the device is on because of heat produced by the thin-film transistor elements. In this embodiment, there is a heatsink film 3 between the first substrate 2 (thin-film transistor elements 11) and the first alignment film 4, and even if the manufacturer uses a liquid crystal material having a low nematic-isotropic phase transition temperature (e.g., 97° C. or lower) aiming at quicker response, the heatsink film 3 will prevent the liquid crystal layer 5 from undergoing a phase transition while the device is on.

The liquid crystal material forming the liquid crystal layer 5 may be a negative liquid crystal material, which has a negative dielectric anisotropy (Δε<0), or may be a positive liquid crystal material, which has a positive dielectric anisotropy (Δε>0). The absolute dielectric anisotropy of the liquid crystal material forming the liquid crystal layer 5 may be 3.0 or less. Known liquid crystal display devices may use a liquid crystal material having a small absolute dielectric anisotropy with the aim of quicker response, but such a liquid crystal material has caused the thin-film transistor elements to produce much heat because of a high driving voltage, and the heat has caused the liquid crystal layer to readily undergo a phase transition in the region near the thin-film transistor elements while the device was on. In this embodiment, there is a heatsink film 3 between the first substrate 2 (thin-film transistor elements 11) and the first alignment film 4, and even if the manufacturer uses a liquid crystal material having a small absolute dielectric anisotropy (e.g., 3.0 or less) aiming at quicker response, the heatsink film 3 will prevent the liquid crystal layer 5 from undergoing a phase transition while the device is on. An absolute dielectric anisotropy of the liquid crystal material forming the liquid crystal layer 5 of more than 3.0 can affect the response characteristics of the liquid crystal display device 1a.

Overall, in this embodiment, the heatsink film advantages the liquid crystal display device even if it is expected that the liquid crystal layer will readily undergo a phase transition while the device is on because of, in particular, conditions like the characteristics of the first alignment film and the characteristics of the liquid crystal layer.

The liquid crystal display device 1a may further has a pair of polarizers on the side of the first substrate 2 opposite the liquid crystal layer 5 and on the side of the second substrate 7 opposite the liquid crystal layer 5. The pair of polarizers can be, for example, linear polarizers (absorptive polarizers) that are polyvinyl alcohol (PVA) films oriented following dyeing with or adsorption of an anisotropic material, such as an iodine complex (or dye).

The liquid crystal display device 1a may further have a backlight on the side of the first substrate 2 opposite the liquid crystal layer 5. This makes the liquid crystal display device 1a a transmissive liquid crystal display device. The backlighting can be of any type, and examples include edge backlighting and direct backlighting. The light source for backlighting can be of any type, and examples include light-emitting diodes (LEDs) and cold cathode fluorescent lamps (CCFLs).

Besides the components described above, the liquid crystal display device 1a may further have components that are used commonly in the field of liquid crystal display devices. For example, the liquid crystal display device 1a may optionally have components like external circuits, such as a tape carrier package (TCP) and a printed circuit board (PCB); optical films, such as a viewing-angle widening film and a brightness enhancement film; and a bezel (frame).

### (2) Method for Producing a Liquid Crystal Display Device

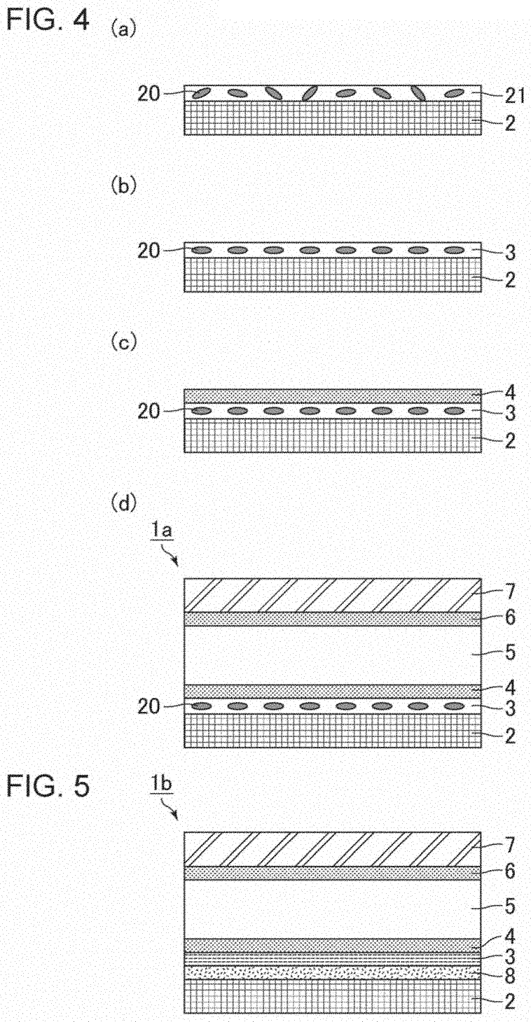

The following describes a method for producing a liquid crystal display device according to Embodiment 1 with reference to FIG. 4 (and FIGS. 2 and 3 as necessary). FIG. 4 includes cross-sectional schematic diagrams for describing a method for producing a liquid crystal display device according to Embodiment 1. The details of a component (material) used in the production of the liquid crystal display device may be omitted if already described earlier herein.

### <Application of a Liquid-Crystalline Composition>

First, as illustrated in FIG. 4 (a), a liquid-crystalline composition 21 containing at least one liquid-crystalline monomer and inorganic fine particles 20 is applied to the surface of a first substrate 2.

Preferably, the liquid-crystalline monomer is represented by chemical formula (1) below.

P¹-Sp¹-R¹-A¹-(Z¹-A²)ₙ-R² (1)

(In chemical formula (1) above, R² represents an —R³-Sp²-P² group, hydrogen atom, halogen atom, —CN group, —NO₂ group, —NCO group, —NCS group, —OCN group, —SCN group, —SF; group, or linear or branched C1 to C18 alkyl group. P¹ and P² may be the same or different and each represent an acryloyloxy group or methacryloyloxy group. Sp¹ and Sp² may be the same or different and each represent a linear, branched, or cyclic C1 to C6 alkylene group, linear, branched, or cyclic C1 to C6 alkyleneoxy group, or direct bond. R¹ and R³ may be the same or different and each represent an —O— group, —S— group, —NH— group, —CO— group, —COO— group, —OCO— group, or direct bond. A¹ and A² may be the same or different and each represent a 1,4-phenylene group, naphthalen-2,6-diyl group, or 1,4-cyclohexylene group. The hydrogen atoms A¹ and A² have may be substituted with a fluorine atom, chlorine atom, —CN group, or C1 to C6 alkyl group, alkoxy group, alkylcarbonyl group, alkoxycarbonyl group, or alkylcarbonyloxy group. Z=represents an —O— group, —S— group, —NH— group, —CO— group, —COO— group, —OCO— group, or direct bond. n represents 0, 1, 2, or 3.)

If the first alignment film 4, to be formed later, is a polyimide-based alignment film, it is preferred that R=(R³) and Z¹ in chemical formula (1) above be —NH— groups, —CO— groups, —COO— groups, or —OCO— groups. This improves adhesion to the first alignment film 4. Preferably, at least one of A¹ and A² in chemical formula (1) above is a 1,4-phenylene group or naphthalen-2,6-diyl group. This promotes interactions with aromatic units in the first alignment film 4.

More preferably, the liquid-crystalline monomer includes at least one of the monomers represented by chemical formulae (2) and (3) below. If, for example, the first alignment film 4, to be formed later, is a polyimide-based alignment film, the use of such liquid-crystalline monomer(s) ensures uniform placement of the first alignment film 4 on the surface of the heatsink film 3, to be formed later, by virtue of high compatibility of the monomer(s) with the polyamic acid precursor of the alignment film. As a result, low contrast of the liquid crystal display device 1a, to be formed later, will be prevented.

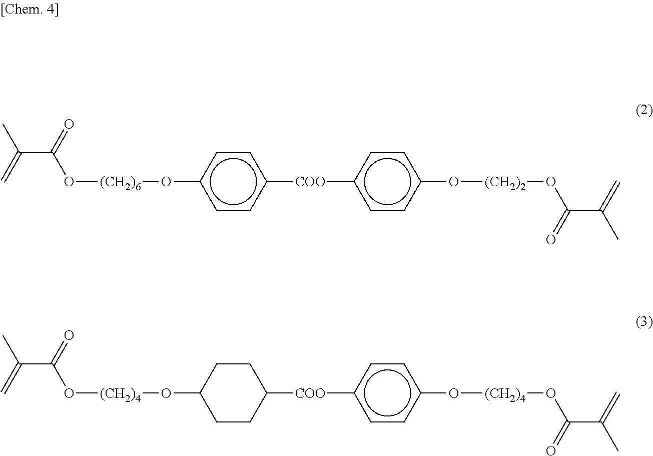

Preferably, the inorganic fine particles 20 are at least one nitride. The nitride preferably includes at least one compound selected from the group consisting of boron nitride, silicon nitride, and aluminum nitride. With such inorganic fine particles 20, the resulting heatsink film 3 will be one in which heat produced by the thin-film transistor elements 11 spreads in-plane efficiently.

In the liquid-crystalline composition 21, the percentage by weight of the inorganic fine particles 20 to the liquid-crystalline monomer is preferably 10% by weight or more. If the percentage by weight of the inorganic fine particles 20 to the liquid-crystalline monomer is 10% by weight or more, heat produced by the thin-film transistor elements 11 will efficiently spread in-plane with respect to the heatsink film 3, to be formed later. Too high a percentage by weight of the inorganic fine particles 20 to the liquid-crystalline monomer, however, can lead to low contrast of the liquid crystal display device 1a, to be formed later, as a result of light scattering by the inorganic fine particles 20. In light of these, the percentage by weight of the inorganic fine particles 20 to the liquid-crystalline monomer is preferably 40% by weight or less.

The liquid-crystalline composition 21 may further contain a polymerization initiator. This allows for efficient initiation of the polymerization of the liquid-crystalline monomer in a later step. An example of a polymerization initiator is an initiator for radical polymerization.

The liquid-crystalline composition 21 may further contain a solvent. This is an efficient way to improve the compatibility between the liquid-crystalline monomer and the inorganic fine particles 20. An example of a solvent is toluene.

### <Formation of a Heatsink Film>

Then the liquid-crystalline composition 21 is exposed to light, polymerizing the liquid-crystalline monomer and thereby forming a heatsink film 3 that overlaps the thin-film transistor elements 11 as illustrated in FIGS. 2 and 3. The heatsink film 3 is a film that contains at least one liquid-crystalline polymer as the polymerized form of the liquid-crystalline monomer and also contains the inorganic fine particles 20. The inorganic fine particles 20 have been dispersed in the liquid-crystalline polymer. Then the surface of the heatsink film 3 is rubbed, and, as a result, the liquid-crystalline polymer is aligned in-plane with respect to the heatsink film 3.

The liquid-crystalline polymer is aligned not along the thickness of the heatsink film 3 but in-plane with respect to the heatsink film 3. The inorganic fine particles 20 are uniformly distributed along the orientation of the liquid-crystalline polymer and in consequence, as illustrated in FIG. 4 (b), are uniformly distributed in-plane with respect to the heatsink film 3. By virtue of the heatsink film 3, therefore, heat produced by the thin-film transistor elements 11 will spread in-plane with respect to the heatsink film 3 through the liquid-crystalline polymer and the inorganic fine particles 20. As a result, it will become less likely that the spread of heat produced by the thin-film transistor elements 11 is limited to the region of the liquid crystal layer 5, to be formed later, near the thin-film transistor elements 11, and local temperature elevation in the liquid crystal layer 5 will become less likely. The liquid crystal layer 5 will therefore be prevented from undergoing a phase transition while the device is on.

In the formation of the heatsink film 3, radical polymerization or condensation polymerization may be performed to polymerize the liquid-crystalline monomer.

In the formation of the heatsink film 3, the light to which the liquid-crystalline composition 21 is exposed may be ultraviolet radiation or may be visible light. The use of ultraviolet radiation is particularly preferred. The ultraviolet radiation may be unpolarized ultraviolet radiation or may be polarized ultraviolet radiation.

The wavelength of the light to which the liquid-crystalline composition 21 is preferably between 310 and 400 nm. If the wavelength of the light to which the liquid-crystalline composition 21 is exposed is shorter than 310 nm, the liquid-crystalline monomer in the liquid-crystalline composition 21 can decompose (or the liquid-crystalline polymer(s) formed as a result of the polymerization of the liquid-crystalline monomer can decompose), and dissolution of the decomposition products into the liquid crystal layer 5, to be formed later, can cause a decrease in voltage holding ratio. If the polymerization proceeds even through exposure to light with a wavelength longer than 400 nm, then the polymerization will proceed even with light emitted from, for example, a backlight. This means unreacted monomers will polymerize while the liquid crystal display device 1a, to be formed later, is in use. This can cause the retardation of the heatsink film 3 to change, causing a loss of contrast, while the liquid crystal display device 1a is in use.

If the liquid-crystalline composition 21 is irradiated with ultraviolet radiation, the dose of the ultraviolet radiation is preferably between 0.01 and 10 J/cm². If the dose of the ultraviolet radiation with which the liquid-crystalline composition 21 is irradiated is lower than 0.01 J/cm², the polymerization can be incomplete, leaving much unreacted monomer, and dissolution of the unreacted monomers into the liquid crystal layer 5, to be formed later, can cause a decrease in voltage holding ratio. If the dose of the ultraviolet radiation with which the liquid-crystalline composition 21 is irradiated is higher than 10 J/cm², the liquid-crystalline monomer in the liquid-crystalline composition 21 can decompose (or the liquid-crystalline polymer(s) formed as a result of the polymerization of the liquid-crystalline monomer can decompose), and dissolution of the decomposition products into the liquid crystal layer 5, to be formed later, can cause a decrease in voltage holding ratio.

In the formation of the heatsink film 3, the exposure of the liquid-crystalline composition 21 to light may be preceded by prefiring as a process of removing any solvent in the liquid-crystalline composition 21. Besides it, after the exposure of the liquid-crystalline composition 21 to light, firing as a process of completely removing the solvent may be performed at a higher temperature than the prefiring.

The thickness of the heatsink film 3 is not critical, but preferably is between 30 and 3000 nm. If the thickness of the heatsink film 3 is smaller than 30 nm, heat produced by the thin-film transistor elements 11 may spread preferentially to the region of the liquid crystal layer 5, to be formed later, near the thin-film transistor elements 11. If the thickness of the heatsink film 3 is larger than 3000 nm, the display characteristics (in particular, contrast) of the liquid crystal display device 1a, to be formed later, may be affected, for example as a result of a retardation produced by the heatsink film 3.

### <Formation of a First Alignment Film>

Then, as illustrated in FIG. 4 (c), a first alignment film 4 is formed on the surface of the heatsink film 3.

In the formation of the first alignment film 4, it may be formed by applying an alignment-film material to or depositing a coating of an alignment-film material on the surface of the heatsink film 3, optionally with subsequent prefiring, firing, treatment for alignment (e.g., photoalignment or rubbing), etc.

The first alignment film 4 may be a photoalignment film, an alignment film that has at least one photoreactive functional group. Preferably, the photoreactive functional group includes at least one of the azobenzene group and the cinnamate group. With such a first alignment film 4, the liquid crystal display device 1a, to be formed later, will achieve high contrast.

The electrical resistance of the first alignment film 4 may be 1×10⁴ Ω·cm or less. In this embodiment, there is a heatsink film 3 between the first substrate 2 (thin-film transistor elements 11) and the first alignment film 4, and even if the electrical resistance of the first alignment film 4 is low (e.g., 1×10 Ω·cm or less), the heatsink film 3 will prevent heat produced by the thin-film transistor elements 11 from spreading readily to the liquid crystal layer 5, to be formed later, through the first alignment film 4. As a result, the liquid crystal layer 5 will be prevented from undergoing a phase transition while the device is on. An electrical resistance of the first alignment film 4 higher than 1×10¹⁴ Ω·cm can affect the contrast of the liquid crystal display device 1a, to be formed later.

The thickness of the first alignment film 4 may be 120 nm or less. In this embodiment, there is a heatsink film 3 between the first substrate 2 (thin-film transistor elements 11) and the first alignment film 4, and even if the thickness of the first alignment film 4 is small (e.g., 120 nm or less), the heatsink film 3 will prevent heat produced by the thin-film transistor elements 11 from spreading readily to the liquid crystal layer 5, to be formed later, through the first alignment film 4. As a result, the liquid crystal layer 5 will be prevented from undergoing a phase transition while the device is on.

### <Completion of the Liquid Crystal Display Device>

Lastly, the first substrate 2 and a second substrate 7 are joined together with a sealant (not illustrated) with a liquid crystal layer 5 therebetween, and a liquid crystal display device 1a as illustrated in FIG. 4 (d) is complete. On the surface of the second substrate 7 closer to the liquid crystal layer 5, there may be a second alignment film 6 as illustrated in FIG. 4 (d). Components such as polarizers and a backlight may optionally be attached to the liquid crystal display device 1a.

Examples of sealants include ones containing resins, such as epoxy resin and (meth)acrylic resin, optionally with inorganic filler, organic filler, a curing agent, etc. The sealant may be one that cures when exposed to light (photocurable sealant), may be one that cures when exposed to heat (thermosetting sealant), or may be one that is cured using both (photocurable and thermosetting sealant). More specifically, the sealant may be one that cures when exposed to ultraviolet radiation (ultraviolet-curable sealant), may be one that cures when exposed to heat (thermosetting sealant), or may be one that is cured using both (ultraviolet-curable and thermosetting sealant).

The liquid crystal layer 5 can be formed by, for example, sealing in a liquid crystal material between the first and second substrates 2 and 7, for example by drop filling or injection.

If the formation of the liquid crystal layer 5 is by drop filling, an example of a process that can be used is as follows. First, the sealant is applied to the surface of one of the first and second substrates 2 and 7, and drops of the liquid crystal material are put on the surface of the other. Then the first and second substrates 2 and 7 are joined together using the sealant, forming a liquid crystal layer 5.

If the formation of the liquid crystal layer 5 is by injection, an example of a process that can be used is as follows. First, the sealant is applied to the surface of one of the first and second substrates 2 and 7, and then the first and second substrates 2 and 7 are joined together using the sealant. Then the liquid crystal material is injected between the first and second substrates 2 and 7, forming a liquid crystal layer 5. When the liquid crystal material is injected, a vacuum may be created between the first and second substrates 2 and 7.

In the formation of the liquid crystal layer 5, the sealant may have been cured beforehand or may not.

Preferably, the liquid crystal material forming the liquid crystal layer 5 is a nematic liquid crystal material. The nematic liquid crystal material may be one that transforms from a nematic into an isotropic phase with increasing temperature. In this case, the nematic-isotropic phase transition temperature of the liquid crystal material forming the liquid crystal layer 5 may be 97° C. or lower. In this embodiment, there is a heatsink film 3 between the first substrate 2 (thin-film transistor elements 11) and the first alignment film 4, and even if the manufacturer uses a liquid crystal material having a low nematic-isotropic phase transition temperature (e.g., 97° C. or lower) aiming at quicker response, the heatsink film 3 will prevent the liquid crystal layer 5 from undergoing a phase transition while the device is on.

The liquid crystal material forming the liquid crystal layer 5 may be a negative liquid crystal material, which has a negative dielectric anisotropy (Δε<0), or may be a positive liquid crystal material, which has a positive dielectric anisotropy (Δε>0). The absolute dielectric anisotropy of the liquid crystal material forming the liquid crystal layer 5 may be 3.0 or less. In this embodiment, there is a heatsink film 3 between the first substrate 2 (thin-film transistor elements 11) and the first alignment film 4, and even if the manufacturer uses a liquid crystal material having a small absolute dielectric anisotropy (e.g., 3.0 or less) aiming at quicker response, the heatsink film 3 will prevent the liquid crystal layer 5 from undergoing a phase transition while the device is on. An absolute dielectric anisotropy of the liquid crystal material forming the liquid crystal layer 5 of more than 3.0 can affect the response characteristics of the liquid crystal display device 1a.

Overall, in this embodiment, the heatsink film advantages the liquid crystal display device even if it is expected that the liquid crystal layer will readily undergo a phase transition while the device is on because of, in particular, conditions like the characteristics of the first alignment film and the characteristics of the liquid crystal layer.

### Embodiment 2

The following describes a liquid crystal display device according to Embodiment 2 and a method for producing it. Embodiment 2 is the same as Embodiment 1 except that it further has a heatsink-film alignment film between the first substrate and the heatsink film, so details in common with Embodiment 1 may be omitted.

### (1) Liquid Crystal Display Device

The following describes a liquid crystal display device according to Embodiment 2 with reference to FIG. 5. FIG. 5 is a cross-sectional schematic diagram illustrating a liquid crystal display device according to Embodiment 2.

The liquid crystal display device 1b has a first substrate 2, a heatsink-film alignment film 8, a heatsink film 3, a first alignment film 4, a liquid crystal layer 5, a second alignment film 6, and a second substrate 7 in order.

### <First Substrate>

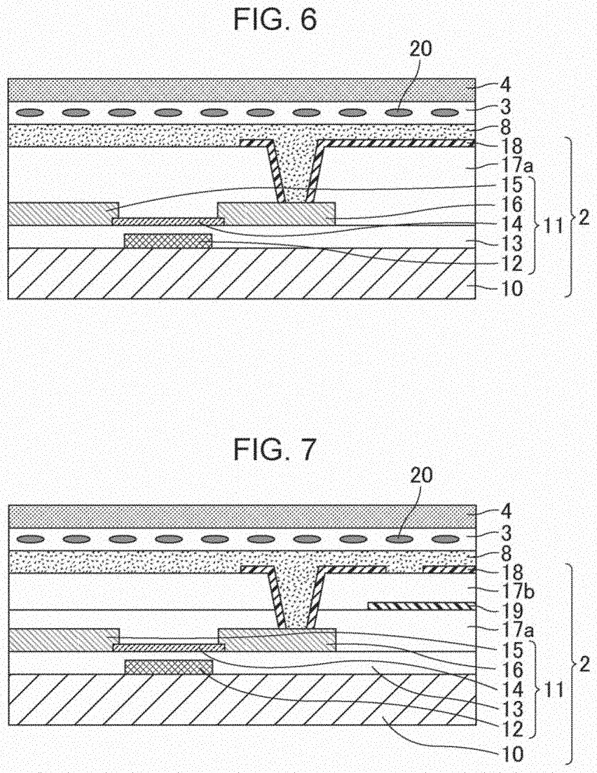

In Embodiment 2, too, examples of configurations of the first substrate 2 include Configurations 1 and 2 similar to those in Embodiment 1 (FIGS. 2 and 3), which are illustrated in FIGS. 6 and 7. FIG. 6 is a cross-sectional schematic diagram illustrating Configuration 1 of the first substrate in FIG. 5. FIG. 7 is a cross-sectional schematic diagram illustrating Configuration 2 of the first substrate in FIG. 5. To help the reader understand the relationship with FIG. 5, FIGS. 6 and 7 also include the heatsink-film alignment film 8, the heatsink film 3, and the first alignment film 4.

### <Heatsink-Film Alignment Film>

The heatsink-film alignment film 8 is between the first substrate 2 and the heatsink film 3 as illustrated in FIGS. 6 and 7. The heatsink-film alignment film 8 functions as a film capable of controlling the orientation of the liquid-crystalline polymer in the heatsink film 3. The heatsink-film alignment film 8 is therefore an efficient way to give the liquid-crystalline polymer an orientation that aligns the polymer in-plane with respect to the heatsink film 3. By virtue of it, the inorganic fine particles 20 are uniformly distributed along the orientation of the liquid-crystalline polymer and in consequence are uniformly distributed in-plane with respect to the heatsink film 3 efficiently.

The heatsink-film alignment film 8 may be a film (whether single-layer or multilayer) formed by at least one compound selected from the group consisting of polyimides, polyamic acids, polymaleimides, polyamides, polysiloxanes, polyphosphazenes, polysilsesquioxanes, and copolymers thereof or an obliquely deposited film of a silicon oxide. Preferably, the heatsink-film alignment film 8 is a homogeneous alignment film (homogeneous photoalignment film). This ensures the liquid-crystalline polymer in the heatsink film 3 is aligned in-plane with respect to the heatsink film 3 efficiently. The inorganic fine particles 20 in the heatsink film 3 are therefore uniformly distributed along the orientation of the liquid-crystalline polymer and in consequence are uniformly distributed in-plane with respect to the heatsink film 3 efficiently. The surface of the heatsink-film alignment film 8 may have been treated for alignment, for example by photoalignment or rubbing.

### (2) Method for Producing a Liquid Crystal Display Device

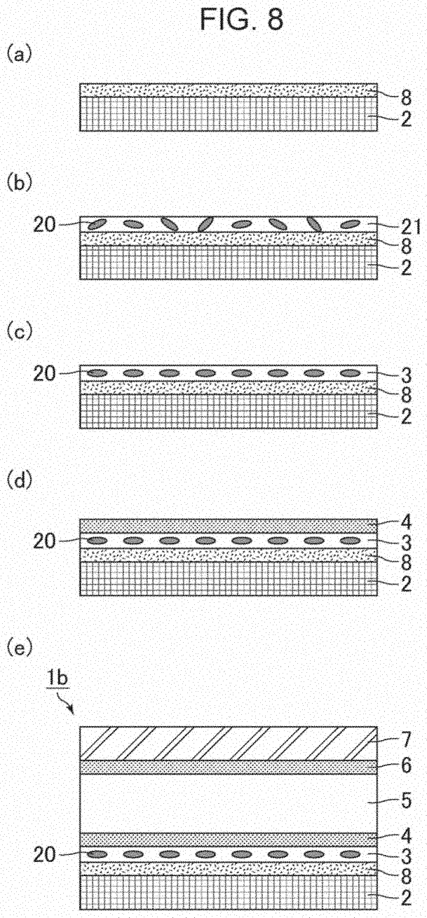

The following describes a method for producing a liquid crystal display device according to Embodiment 2 with reference to FIG. 8 (and FIGS. 6 and 7 as necessary). FIG. 8 includes cross-sectional schematic diagrams for describing a method for producing a liquid crystal display device according to Embodiment 2.

### <Formation of a Heatsink-Film Alignment Film>

First, as illustrated in FIG. 8 (a), a heatsink-film alignment film 8 is formed on the surface of a first substrate 2. The heatsink-film alignment film 8 is a film that will control the orientation of liquid-crystalline polymer(s) in the heatsink film 3, to be formed later.

In the formation of the heatsink-film alignment film 8, it may be formed by applying an alignment-film material to or depositing a coating of an alignment-film material on the surface of the first substrate 2, optionally with subsequent prefiring, firing, treatment for alignment (e.g., photoalignment or rubbing), etc.

### <Application of a Liquid-Crystalline Composition>

Then, as illustrated in FIG. 8 (b), a liquid-crystalline composition 21 containing at least one liquid-crystalline monomer and inorganic fine particles 20 is applied to the surface of the heatsink-film alignment film 8.

### <Formation of a Heatsink Film>

Then the liquid-crystalline composition 21 is exposed to light, polymerizing the liquid-crystalline monomer and thereby forming a heatsink film 3 that overlaps the thin-film transistor elements 11 as illustrated in FIGS. 6 and 7. The heatsink film 3 is a film that contains at least one liquid-crystalline polymer as the polymerized form of the liquid-crystalline monomer and also contains the inorganic fine particles 20. The inorganic fine particles 20 have been dispersed in the liquid-crystalline polymer. Owing to the effect of the heatsink-film alignment film 8, the liquid-crystalline polymer is aligned in-plane with respect to the heatsink film 3. The inorganic fine particles 20 are therefore uniformly distributed along the orientation of the liquid-crystalline polymer and in consequence, as illustrated in FIG. 8 (c), are uniformly distributed in-plane with respect to the heatsink film 3. At this point, the surface of the heatsink film 3 may be rubbed for better alignment of the liquid-crystalline polymer.

### <Formation of a First Alignment Film>

Then, as illustrated in FIG. 8 (d), a first alignment film 4 is formed on the surface of the heatsink film 3.

### <Completion of the Liquid Crystal Display Device>

Lastly, the first substrate 2 and a second substrate 7 are joined together with a sealant (not illustrated) with a liquid crystal layer 5 therebetween, and a liquid crystal display device 1b as illustrated in FIG. 8 (e) is complete.

### Examples and Comparative Examples

The following describes the present invention by providing examples and comparative examples, but the present invention is not limited to these examples and comparative examples.

In the Examples and Comparative Examples, the following liquid-crystalline compositions were used to produce liquid crystal display devices.

### <Liquid-Crystalline Composition L1>

Liquid-crystalline composition L1 was prepared by adding 5 g of liquid-crystalline monomer M1, represented by chemical formula (2) below, 1 g of boron nitride (inorganic fine particles), and 0.05 g of IGM Resins' “IRGACURE® 651” initiator for radical polymerization to toluene (solvent) and fully dissolving the materials in the toluene by heating the resulting mixture at 50° C. for 1 hour and then leaving it under 25° C. conditions for 12 hours. In liquid-crystalline composition L1, the percentage by weight of boron nitride (inorganic fine particles) to liquid-crystalline monomer M1 was 20% by weight.

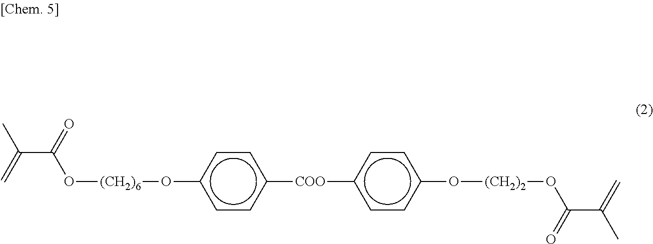

### <Liquid-Crystalline Composition L2>

Liquid-crystalline composition L2 was prepared in the same way as liquid-crystalline composition L1 except that the amount of boron nitride (inorganic fine particles) was changed to 0.5 g. In liquid-crystalline composition L2, the percentage by weight of boron nitride (inorganic fine particles) to liquid-crystalline monomer M1 was 10% by weight.

### <Liquid-Crystalline Composition L3>

Liquid-crystalline composition L3 was prepared in the same way as liquid-crystalline composition L1 except that the amount of boron nitride (inorganic fine particles) was changed to 2 g. In liquid-crystalline composition L3, the percentage by weight of boron nitride (inorganic fine particles) to liquid-crystalline monomer M1 was 40% by weight.

### <Liquid-Crystalline Composition L4>

Liquid-crystalline composition L4 was prepared in the same way as liquid-crystalline composition L1 except that the amount of boron nitride (inorganic fine particles) was changed to 3 g. In liquid-crystalline composition L4, the percentage by weight of boron nitride (inorganic fine particles) to liquid-crystalline monomer M1 was 60% by weight.

### <Liquid-Crystalline Composition L5>

Liquid-crystalline composition L5 was prepared by adding 5 g of liquid-crystalline monomer M2, represented by chemical formula (3) below, 1 g of silicon nitride (inorganic fine particles), and 0.05 g of IGM Resins' “IRGACURE 651” initiator for radical polymerization to toluene (solvent) and fully dissolving the materials in the toluene by heating the resulting mixture at 50° C. for 1 hour and then leaving it under 25° C. conditions for 12 hours. In liquid-crystalline composition L5, the percentage by weight of silicon nitride (inorganic fine particles) to liquid-crystalline monomer M2 was 20% by weight.

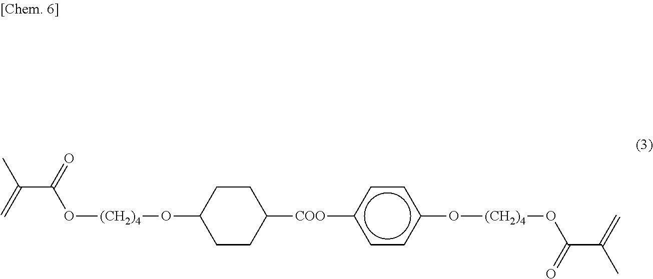

### <Liquid-Crystalline Composition L6>

Liquid-crystalline composition L6 was prepared by adding 5 g of liquid-crystalline monomer M3, represented by chemical formula (4) below, 1 g of boron nitride (inorganic fine particles), and 0.05 g of IGM Resins' “IRGACURE 651” initiator for radical polymerization to toluene (solvent) and fully dissolving the materials in the toluene by heating the resulting mixture at 50° C. for 1 hour and then leaving it under 25° C. conditions for 12 hours. In liquid-crystalline composition L6, the percentage by weight of boron nitride (inorganic fine particles) to liquid-crystalline monomer M3 was 20% by weight.

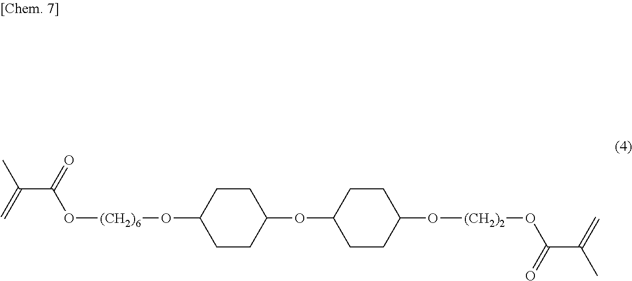

In the Examples and Comparative Examples, the following alignment-film materials were used to produce liquid crystal display devices.

### <Alignment-Film Material T1>

Alignment-film material T1 was a material for homogeneous photoalignment films that contained the azobenzene-derived polyamic acid represented by chemical formula (5) below.

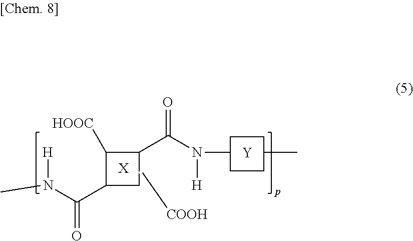

In chemical formula (5) above, X is represented by chemical formula (6-1) below. Y is represented by chemical formula (6-2) below.

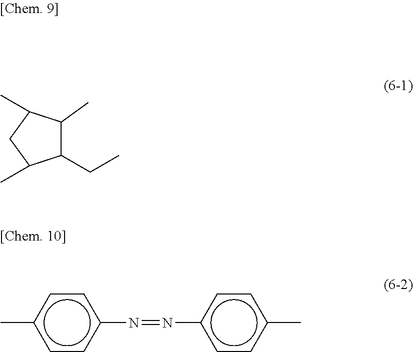

### <Alignment-Film Material T2>

Alignment-film material T2 was a material for homeotropic photoalignment films that contained the polysiloxane represented by chemical formula (7) below.

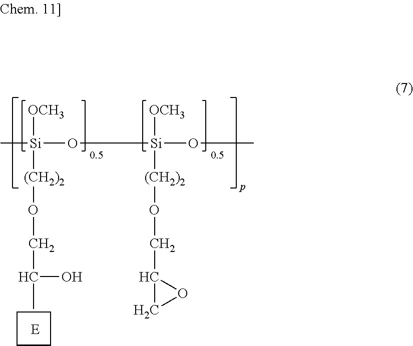

In chemical formula (7) above, E is represented by chemical formula (8-1) or (8-2) below.

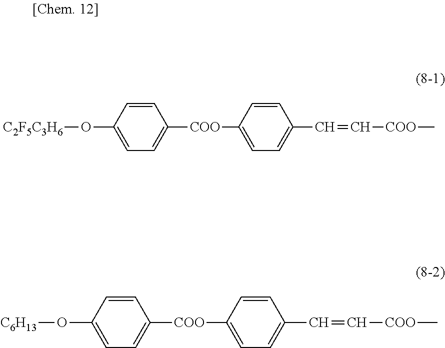

### Example 1

A liquid crystal display device of Example 1 was produced by a production method according to Embodiment 1. First, a first substrate as illustrated in FIG. 3 (Configuration 2) and a second substrate having no electrode were prepared. Then liquid-crystalline composition L1 was applied to the surface of the first substrate. Liquid-crystalline composition L1 was then subjected to 1 minute of prefiring at 90° C., irradiation with unpolarized ultraviolet radiation (dose: 2 J/cm²), and subsequent 30 minutes of firing at 150° C. As a result, the solvent (toluene) in liquid-crystalline composition L1 was removed completely, and a liquid-crystalline polymer was produced as the polymerized form of liquid-crystalline monomer M1, forming a heatsink film that overlapped the thin-film transistor elements present in the first substrate. After that, the surface of the heatsink film was rubbed to align the liquid-crystalline polymer in-plane with respect to the heatsink film and in consequence to achieve uniform distribution of the inorganic fine particles in-plane with respect to the heatsink film. The thickness of the heatsink film was 50 nm.

Then alignment-film material T1 was applied to the surface of the heatsink film on the first substrate and to the surface of the second substrate. Alignment-film material T1 was then subjected to 2 minutes of prefiring at 90° C., 20 minutes of firing at 130° C., irradiation with polarized ultraviolet radiation (dose: 2 J/cm²) in the normal direction, and subsequent 40 minutes of firing at 230° C. As a result, a first alignment film was formed on the surface of the heatsink film on the first substrate, and a second alignment film was formed on the surface of the second substrate. The first and second alignment films were both polyimide-based homogeneous photoalignment films, and their electrical resistance was 5×10¹³ Ω·cm.

Then Sekisui Chemical's “Photolec® S-WB” ultraviolet-curable sealant was applied to the surface of one of the first and second substrates using a dispenser, and drops of a positive liquid crystal material (nematic-isotropic phase transition temperature, 94° C.; dielectric anisotropy, 2.7) were put on the surface of the other. After the first and second substrates were joined together with the sealant in a vacuum to form a liquid crystal layer, the sealant was cured with ultraviolet radiation. Subsequently, the workpiece was heated at 130° C. for 40 minutes for realignment of the liquid crystal layer and then cooled to room temperature. After that, components such as polarizers and a backlight were attached, and a liquid crystal display device of Example 1 (FFS liquid crystal display device) was complete.

### Comparative Example 1

A liquid crystal display device of Comparative Example 1 was produced in the same way as in Example 1 except that the formation of a heatsink film was omitted.

### [Testing 1]

The liquid crystal display devices of Example 1 and Comparative Example 1 were tested as follows. The results are presented in Table 1.

### <Phase Transition of the Liquid Crystal Layer>

The liquid crystal display devices of each Example or Comparative Example were subjected to a high-temperature electrification test, in which the device was continuously put under a voltage at which the device would reach its maximum transmittance (hereinafter, the voltage for maximum transmittance) under 90° C. conditions with the backlight on. After 1000 hours of the high-temperature electrification test, the liquid crystal layer was checked for whether it underwent a phase transition (state of alignment). The voltage for maximum transmittance of the liquid crystal display devices of each Example or Comparative Example was as presented in Table 1.

### <Contrast>

The contrast of the liquid crystal display devices of each Example or Comparative Example was measured using Topcon Technohouse's “SR-UL1.”

### <Response Characteristics>

The liquid crystal display devices of each Example or Comparative Example were subjected to the measurement of the rise time Tr, i.e., time of response to a rise in applied voltage from 0.5 V to the voltage for maximum transmittance (Table 1), and the decay time Td, i.e., time of response to a fall in applied voltage from the voltage for maximum transmittance (Table 1) to 0.5 V, under 25° C. conditions using Otsuka Electronics' “Photal 5200.”

TABLE l

| | Voltage for | Phase | | Response | |
|---|---|---|---|---|---|
| | maximum | transition of | | characteristics | |
| | transmittance | the liquid | | Tr | Td |
| | (V) | crystal layer | Contrast | (ms) | (ms) |
| Example 1 | 6.3 | No | 850 | 6.2 | 6.3 |
| Comparative | | | | | |
| Example 1 | 6.3 | Yes | 850 | 6.3 | 6.3 |

As shown in Table 1, the liquid crystal layer in Example 1 did not undergo a phase transition while the device was on. Example 1, moreover, achieved high contrast by virtue of the first and second alignment films that were homogeneous photoalignment films, and also quick response by virtue of a small absolute dielectric anisotropy and a low nematic-isotropic phase transition temperature of the liquid crystal material.

In Comparative Example 1, the liquid crystal layer underwent a phase transition (transformation from a nematic to an isotropic phase) while the device was on, particularly in the region near the thin-film transistor elements, because of the absence of a heatsink film, although high contrast and quick response were achieved as in Example 1.

### Example 2

A liquid crystal display device of Example 2 was produced by a production method according to Embodiment 2. First, a first substrate as illustrated in FIG. 7 (Configuration 2) and a second substrate having no electrode were prepared. Then JSR's “AL1051” polyimide-based alignment-film material was applied to the surface of the first substrate, and the applied alignment-film material was subjected to 2 minutes of prefiring at 90° C. and subsequent 40 minutes of firing at 200° C. As a result, a heatsink-film alignment film was formed on the surface of the first substrate. After that, the surface of the heatsink-film alignment film was rubbed.

Then liquid-crystalline composition L1 was applied to the surface of the heatsink-film alignment film. Liquid-crystalline composition L1 was then subjected to 1 minute of prefiring at 90° C., irradiation with unpolarized ultraviolet radiation (dose: 2 J/cm²), and subsequent 30 minutes of firing at 150° C. As a result, the solvent (toluene) in liquid-crystalline composition L1 was removed completely, and a liquid-crystalline polymer was produced as the polymerized form of liquid-crystalline monomer M1, forming a heatsink film that overlapped the thin-film transistor elements present in the first substrate. Owing to the effect of the heatsink-film alignment film, the liquid-crystalline polymer was aligned in-plane with respect to the heatsink film. The inorganic fine particles were therefore uniformly distributed along the orientation of the liquid-crystalline polymer and in consequence were uniformly distributed in-plane with respect to the heatsink film. The thickness of the heatsink film was 50 nm.

Then alignment-film material T1 was applied to the surface of the heatsink film on the first substrate and to the surface of the second substrate. Alignment-film material T1 was then subjected to 2 minutes of prefiring at 90° C., 20 minutes of firing at 130° C., irradiation with polarized ultraviolet radiation (dose: 2 J/cm²) in the normal direction, and subsequent 40 minutes of firing at 230° C. As a result, a first alignment film was formed on the surface of the heatsink film on the first substrate, and a second alignment film was formed on the surface of the second substrate. The first and second alignment films were both polyimide-based homogeneous photoalignment films, and their electrical resistance was 5×10¹³ Ω·cm.

Then Sekisui Chemical's “Photolec S-WB” ultraviolet-curable sealant was applied to the surface of one of the first and second substrates using a dispenser, and drops of a positive liquid crystal material (nematic-isotropic phase transition temperature, 96° C.; dielectric anisotropy, 2.6) were put on the surface of the other. After the first and second substrates were joined together with the sealant in a vacuum to form a liquid crystal layer, the sealant was cured with ultraviolet radiation. Subsequently, the workpiece was heated at 130° C. for 40 minutes for realignment of the liquid crystal layer and then cooled to room temperature. After that, components such as polarizers and a backlight were attached, and a liquid crystal display device of Example 2 (FFS liquid crystal display device) was complete.

### Comparative Example 2

A liquid crystal display device of Comparative Example 2 was produced in the same way as in Example 2 except that the formation of a heatsink-film alignment film and that of a heatsink film were omitted.

### Comparative Example 3

A liquid crystal display device of Comparative Example 3 was produced in the same way as in Example 2 except that the formation of a heatsink-film alignment film was omitted and, therefore, that the liquid-crystalline polymer in the heatsink film was not aligned in-plane with respect to the heatsink film (and in consequence the inorganic fine particles in the heatsink film were not uniformly distributed in-plane with respect to the heatsink film).

### [Testing 2]

The liquid crystal display devices of Example 2 and Comparative Examples 2 and 3 were tested in the same way as in Testing 1 above. The results are presented in Table 2.

TABLE 2

| | Voltage for | Phase | | Response | |
|---|---|---|---|---|---|
| | maximum | transition of | | characteristics | |
| | transmittance | the liquid | | Tr | Td |
| | (V) | crystal layer | Contrast | (ms) | (ms) |
| Example 2 | 6.4 | No | 880 | 5.8 | 5.7 |
| Comparative | 6.4 | Yes | 870 | 5.9 | 5.7 |
| Example 2 | | | | | |
| Comparative | 6.4 | Partial | 860 | 5.7 | 5.8 |
| Example 3 | | | | | |

As shown in Table 2, the liquid crystal layer in Example 2 did not undergo a phase transition while the device was on. Example 2, moreover, achieved high contrast by virtue of the first and second alignment films that were homogeneous photoalignment films, and also quick response by virtue of a small absolute dielectric anisotropy and a low nematic-isotropic phase transition temperature of the liquid crystal material.

In Comparative Example 2, although high contrast and quick response were achieved as in Example 2, the liquid crystal layer underwent a phase transition (transformation from a nematic to an isotropic phase) while the device was on, particularly in the region near the thin-film transistor elements, because of the absence of a heatsink film.

In Comparative Example 3, although high contrast and quick response were achieved as in Example 2, the liquid crystal layer underwent a phase transition (transformation from a nematic to an isotropic phase) in part of the region near the thin-film transistor elements while the device was on, because the liquid-crystalline polymer in the heatsink film was not aligned in-plane with respect to the heatsink film (and in consequence the inorganic fine particles in the heatsink film were not uniformly distributed in-plane with respect to the heatsink film). The inventors believe this is because much of heat produced by the thin-film transistor elements also spread along the thickness of the heatsink film, making local temperature elevation in the liquid crystal layer more likely to occur.

### Example 3

A liquid crystal display device of Example 3 was produced by a production method according to Embodiment 2. First, a first substrate as illustrated in FIG. 6 (Configuration 1) and a second substrate having electrodes on its surface were prepared. Then JSR's “AL1051” polyimide-based alignment-film material was applied to the surface of the first substrate, and the applied alignment-film material was subjected to 2 minutes of prefiring at 90° C. and subsequent 40 minutes of firing at 200° C. As a result, a heatsink-film alignment film was formed on the surface of the first substrate. After that, the surface of the heatsink-film alignment film was rubbed.

Then liquid-crystalline composition L5 was applied to the surface of the heatsink-film alignment film. Liquid-crystalline composition L5 was then subjected to 1 minute of prefiring at 90° C., irradiation with unpolarized ultraviolet radiation (dose: 3 J/cm²), and subsequent 30 minutes of firing at 150° C. As a result, the solvent (toluene) in liquid-crystalline composition L5 was removed completely, and a liquid-crystalline polymer was produced as the polymerized form of liquid-crystalline monomer M2, forming a heatsink film that overlapped the thin-film transistor elements present in the first substrate. Owing to the effect of the heatsink-film alignment film, the liquid-crystalline polymer was aligned in-plane with respect to the heatsink film. The inorganic fine particles were therefore uniformly distributed along the orientation of the liquid-crystalline polymer and in consequence were uniformly distributed in-plane with respect to the heatsink film. The thickness of the heatsink film was 60 nm.

Then alignment-film material T2 was applied to the surface of the heatsink film on the first substrate and to the surface of the second substrate. Alignment-film material T2 was then subjected to 2 minutes of prefiring at 90° C., 40 minutes of firing at 230° C., and subsequent irradiation with polarized ultraviolet radiation (dose: 20 mJ/cm²) obliquely at an angle of 40°. As a result, a first alignment film was formed on the surface of the heatsink film on the first substrate, and a second alignment film was formed on the surface of the second substrate. The first and second alignment films were both polysiloxane-based homeotropic photoalignment films, and their electrical resistance was 1×10¹⁴ Ω·cm.

Then Sekisui Chemical's “Photolec S-WB” ultraviolet-curable sealant was applied to the surface of one of the first and second substrates using a dispenser, and drops of a negative liquid crystal material (nematic-isotropic phase transition temperature, 92° C.; dielectric anisotropy, −2.8) were put on the surface of the other. After the first and second substrates were joined together with the sealant in a vacuum to form a liquid crystal layer, the sealant was cured with ultraviolet radiation. Subsequently, the workpiece was heated at 130° C. for 40 minutes for realignment of the liquid crystal layer and then cooled to room temperature. After that, components such as polarizers and a backlight were attached, and a liquid crystal display device of Example 3 (UV²A liquid crystal display device) was complete.

### Comparative Example 4

A liquid crystal display device of Comparative Example 4 was produced in the same way as in Example 3 except that the formation of a heatsink-film alignment film and that of a heatsink film were omitted.

### Comparative Example 5

A liquid crystal display device of Comparative Example 5 was produced in the same way as in Example 3 except that the formation of a heatsink-film alignment film was omitted and, therefore, that the liquid-crystalline polymer in the heatsink film was not aligned in-plane with respect to the heatsink film (and in consequence the inorganic fine particles in the heatsink film were not uniformly distributed in-plane with respect to the heatsink film).

### [Testing 3]

The liquid crystal display devices of Example 3 and Comparative Examples 4 and 5 were tested in the same way as in Testing 1 above. The results are presented in Table 3.

TABLE 3

| | Voltage for | Phase | | Response | |
|---|---|---|---|---|---|
| | maximum | transition of | | characteristics | |
| | transmittance | the liquid | | Tr | Td |
| | (V) | crystal layer | Contrast | (ms) | (ms) |
| Example 3 | 7.8 | No | 2500 | 11.8 | 12.6 |
| Comparative | 7.8 | Yes | 2500 | 12.0 | 12.5 |
| Example 4 | | | | | |
| Comparative | 7.8 | Yes | 2500 | 11.9 | 12.7 |
| Example 5 | | | | | |

As shown in Table 3, the liquid crystal layer in Example 3 did not undergo a phase transition while the device was on. Example 3, moreover, achieved high contrast by virtue of the first and second alignment films that were homeotropic photoalignment films, and also quick response by virtue of a small absolute dielectric anisotropy and a low nematic-isotropic phase transition temperature of the liquid crystal material.

In Comparative Example 4, although high contrast and quick response were achieved as in Example 3, the liquid crystal layer underwent a phase transition (transformation from a nematic to an isotropic phase) while the device was on, particularly in the region near the thin-film transistor elements, because of the absence of a heatsink film.

In Comparative Example 5, although high contrast and quick response were achieved as in Example 3, the liquid crystal layer underwent a phase transition (transformation from a nematic to an isotropic phase) in the region near the thin-film transistor elements while the device was on, because the liquid-crystalline polymer in the heatsink film was not aligned in-plane with respect to the heatsink film (and in consequence the inorganic fine particles in the heatsink film were not uniformly distributed in-plane with respect to the heatsink film). The inventors believe this is because much of heat produced by the thin-film transistor elements also spread along the thickness of the heatsink film, making local temperature elevation in the liquid crystal layer more likely to occur.

### Example 4

A liquid crystal display device of Example 4 was produced in the same way as in Example 1 except that the heatsink film was formed using liquid-crystalline composition L2.

### Example 5

A liquid crystal display device of Example 5 was produced in the same way as in Example 1 except that the heatsink film was formed using liquid-crystalline composition L3.

### Example 6

A liquid crystal display device of Example 6 was produced in the same way as in Example 1 except that the heatsink film was formed using liquid-crystalline composition L4.

### [Testing 4]

The liquid crystal display devices of Examples 1 and 4 to 6 were tested in the same way as in Testing 1 above. The results are presented in Table 4. Table 4 also presents the percentage by weight of the inorganic fine particles (in these Examples, of boron nitride) to the liquid-crystalline monomer (in these Examples, liquid-crystalline monomer M1) (hereinafter the weight percentage of inorganic fine particles).

TABLE 4

| | Weight | | | | | |
|---|---|---|---|---|---|---|
| | percentage of | Voltage for | Phase | | Response | |
| | inorganic fine | maximum | transition of | | characteristics | |
| | particles | transmittance | the liquid | | Tr | Td |
| | (% by weight) | (V) | crystal layer | Contrast | (ms) | (ms) |
| Example 4 | 10 | 6.3 | No | 890 | 6.2 | 6.3 |
| Example 1 | 20 | 6.3 | No | 850 | 6.2 | 6.3 |
| Example 5 | 40 | 6.3 | No | 790 | 6.3 | 6.3 |
| Example 6 | 60 | 6.3 | No | 530 | 6.2 | 6.4 |

As shown in Table 4, the liquid crystal layer in Examples 4 to 6, like that in Example 1, did not undergo a phase transition while the device was on. Examples 4 to 6, moreover, achieved quick response by virtue of a small absolute dielectric anisotropy and a low nematic-isotropic phase transition temperature of the liquid crystal material, as did Example 1. When Examples 1 and 4 to 6 were compared, it was found that the contrast decreases with increasing weight percentage of inorganic fine particles. The inventors believe this is because the effect of light scattering by the inorganic fine particles became more significant with increasing weight percentage of inorganic fine particles. Another possibility is that light scattering by the inorganic fine particles may have caused the treatment for photoalignment (irradiation with polarized ultraviolet radiation) performed in the formation of the first and second alignment films (homogeneous photoalignment films) to be insufficient.

### Example 7

A liquid crystal display device of Example 7 was produced in the same way as in Example 1 except that the heatsink film was formed using liquid-crystalline composition L6.

### [Testing 5]

The liquid crystal display devices of Examples 1 and 7 were tested in the same way as in Testing 1 above. The results are presented in Table 5.

TABLE 5

| | Voltage for | Phase | | Response | |
|---|---|---|---|---|---|
| | maximum | transition of | | characteristics | |
| | transmittance | the liquid | | Tr | Td |
| | (V) | crystal layer | Contrast | (ms) | (ms) |
| Example 7 | 6.3 | No | 780 | 6.3 | 6.3 |
| Example 1 | 6.3 | No | 850 | 6.2 | 6.3 |

As shown in Table 5, the liquid crystal layer in Example 7, like that in Example 1, did not undergo a phase transition while the device was on. Example 7, moreover, achieved quick response by virtue of a small absolute dielectric anisotropy and a low nematic-isotropic phase transition temperature of the liquid crystal material, as did Example 1. Contrast, however, was low in Example 7 compared with Example 1. With regard to this, the inventors believe a possibility is that the first alignment film may have been placed nonuniformly on the surface of the heatsink film because of low compatibility between the azobenzene-derived polyamic acid in alignment-film material T1 and the polymerized form (liquid-crystalline polymer) of liquid-crystalline monomer M3 in the heatsink film.

### APPENDIX

An aspect of the present invention may be a liquid crystal display device that includes a first substrate having a thin-film transistor element, a heatsink film overlapping the thin-film transistor element, a first alignment film, a liquid crystal layer, and a second substrate in order. The heatsink film contains at least one liquid-crystalline polymer as the polymerized form of at least one liquid-crystalline monomer and also contains inorganic fine particles, and the liquid-crystalline polymer is aligned in-plane with respect to the heatsink film. This aspect provides a liquid crystal display device whose liquid crystal layer is prevented from undergoing a phase transition while the device is on.

In an aspect of the present invention, there may be a heatsink-film alignment film, a film that controls the orientation of the liquid-crystalline polymer, between the first substrate and the heatsink film. Such an arrangement is an efficient way to give the liquid-crystalline polymer an orientation that aligns the polymer in-plane with respect to the heatsink film. The inorganic fine particles are therefore uniformly distributed along the orientation of the liquid-crystalline polymer and in consequence are uniformly distributed in-plane with respect to the heatsink film efficiently.

In an aspect of the present invention, the liquid-crystalline monomer may be represented by chemical formula (1) below. Such an arrangement allows for effective use of the liquid-crystalline monomer.

P¹-Sp¹-R¹-A¹-(Z¹-A²)ₙ-R² (1)

(In chemical formula (1) above, R=represents an —R³-Sp²-P² group, hydrogen atom, halogen atom, —CN group, —NO₂ group, —NCO group, —NCS group, —OCN group, —SCN group, —SF₆ group, or linear or branched C1 to C18 alkyl group. P¹ and P² may be the same or different and each represent an acryloyloxy group or methacryloyloxy group. Sp¹ and Sp² may be the same or different and each represent a linear, branched, or cyclic C1 to C6 alkylene group, linear, branched, or cyclic C1 to C6 alkyleneoxy group, or direct bond. R¹ and R³ may be the same or different and each represent an —O— group, —S— group, —NH— group, —CO— group, —COO— group, —OCO— group, or direct bond. A¹ and A² may be the same or different and each represent a 1,4-phenylene group, naphthalen-2,6-diyl group, or 1,4-cyclohexylene group. The hydrogen atoms A¹ and A² have may be substituted with a fluorine atom, chlorine atom, —CN group, or C1 to C6 alkyl group, alkoxy group, alkylcarbonyl group, alkoxycarbonyl group, or alkylcarbonyloxy group. Z¹ represents an —O— group, —S— group, —NH— group, —CO— group, —COO— group, —OCO— group, or direct bond. n represents 0, 1, 2, or 3.)

In an aspect of the present invention, the liquid-crystalline monomer may include at least one of the monomers represented by chemical formulae (2) and (3) below. If, for example, the first alignment film is a polyimide-based alignment film, such an arrangement allows the first alignment film to be placed uniformly on the surface of the heatsink film by virtue of high compatibility between the polyamic acid precursor of the alignment film and the polymerized form (liquid-crystalline polymer) of the liquid-crystalline monomer. As a result, low contrast of the liquid crystal display device is prevented.

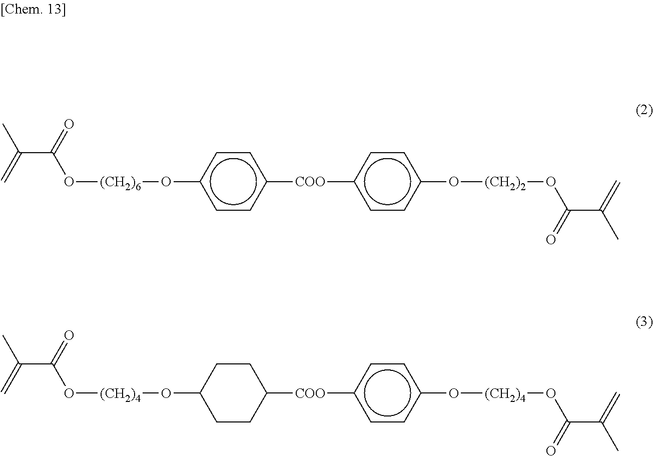

In an aspect of the present invention, the inorganic fine particles may be at least one nitride. In an aspect of the present invention, furthermore, the nitride may include at least one compound selected from the group consisting of boron nitride, silicon nitride, and aluminum nitride. Such arrangements ensure heat produced by the thin-film transistor elements will spread in-plane with respect to the heatsink film efficiently.

In an aspect of the present invention, the absolute dielectric anisotropy of the liquid crystal material forming the liquid crystal layer may be 3.0 or less. Such an arrangement helps achieve quick response while preventing the liquid crystal layer from undergoing a phase transition while the device is on.

In an aspect of the present invention, the electrical resistance of the first alignment film may be 1×10¹⁴ Ω·cm or less. If the FFS or other homogeneous alignment mode is used, such an arrangement helps reduce flickers while preventing the liquid crystal layer from undergoing a phase transition while the device is on.

In an aspect of the present invention, the percentage by weight of the inorganic fine particles to the liquid-crystalline monomer may be 10% by weight or more. Such an arrangement ensures heat produced by the thin-film transistor element will spread in-plane with respect to the heatsink film efficiently, thereby ensuring the liquid crystal layer will be fully prevented from undergoing a phase transition while the device is on.

In an aspect of the present invention, the first alignment film may be a photoalignment film, an alignment film having at least one photoreactive functional group. In an aspect of the present invention, furthermore, the photoreactive functional group may include at least one of the azobenzene group and the cinnamate group. Such arrangements give the liquid crystal display device high contrast.

Another aspect of the present invention may be a method for producing a liquid crystal display device that includes a first substrate having a thin-film transistor element, a liquid crystal layer, and a second substrate in order. The method includes step (1) as a step of applying a liquid-crystalline composition containing at least one liquid-crystalline monomer and inorganic fine particles to the surface of the first substrate, step (2) as a step of exposing the liquid-crystalline composition to light to polymerize the liquid-crystalline monomer and thereby to form a heatsink film overlapping the thin-film transistor element, and step (3) as a step of forming a first alignment film on the surface of the heatsink film. The heatsink film contains at least one liquid-crystalline polymer as the polymerized form of the liquid-crystalline monomer and also contains the inorganic fine particles, and the liquid-crystalline polymer is aligned in-plane with respect to the heatsink film. This aspect enables production of a liquid crystal display device whose liquid crystal layer will be prevented from undergoing a phase transition while the device is on.

In another aspect of the present invention, the method for producing a liquid crystal display device may further include, between steps (2) and (3), step (4) as a step of rubbing the surface of the heatsink film. Such an arrangement is an efficient way to give the liquid-crystalline polymer an orientation that aligns the polymer in-plane with respect to the heatsink film. The inorganic fine particles are therefore uniformly distributed along the orientation of the liquid-crystalline polymer and in consequence are uniformly distributed in-plane with respect to the heatsink film efficiently.

In another aspect of the present invention, the method for producing a liquid crystal display device may further include, before step (1), step (5) as a step of forming a heatsink-film alignment film, a film that controls the orientation of the liquid-crystalline polymer, on the surface of the first substrate. Such an arrangement is an efficient way to give the liquid-crystalline polymer an orientation that aligns the polymer in-plane with respect to the heatsink film. The inorganic fine particles are therefore uniformly distributed along the orientation of the liquid-crystalline polymer and in consequence are uniformly distributed in-plane with respect to the heatsink film efficiently.

In another aspect of the present invention, radical polymerization or condensation polymerization of the liquid-crystalline monomer may be performed in step (2). Such an arrangement makes the polymerization of the liquid-crystalline monomer efficient.

In another aspect of the present invention, the liquid-crystalline monomer may be represented by chemical formula (1) below. Such an arrangement allows for effective use of the liquid-crystalline monomer.

P¹-Sp¹-R¹-A¹-(Z¹-A²)ₙ-R² (1)

(In chemical formula (1) above, R² represents an —R³-Sp²-P² group, hydrogen atom, halogen atom, —CN group, —NO₂ group, —NCO group, —NCS group, —OCN group, —SCN group, —SF; group, or linear or branched C1 to C18 alkyl group. P¹ and P² may be the same or different and each represent an acryloyloxy group or methacryloyloxy group. Sp¹ and Sp² may be the same or different and each represent a linear, branched, or cyclic C1 to C6 alkylene group, linear, branched, or cyclic C1 to C6 alkyleneoxy group, or direct bond. R¹ and R³ may be the same or different and each represent an —O— group, —S— group, —NH— group, —CO— group, —COO— group, —OCO— group, or direct bond. A¹ and A² may be the same or different and each represent a 1,4-phenylene group, naphthalen-2,6-diyl group, or 1,4-cyclohexylene group. The hydrogen atoms A¹ and A² have may be substituted with a fluorine atom, chlorine atom, —CN group, or C1 to C6 alkyl group, alkoxy group, alkylcarbonyl group, alkoxycarbonyl group, or alkylcarbonyloxy group. Z¹ represents an —O— group, —S— group, —NH— group, —CO— group, —COO— group, —OCO— group, or direct bond. n represents 0, 1, 2, or 3.)

In another aspect of the present invention, the liquid-crystalline monomer may include at least one of the monomers represented by chemical formulae (2) and (3) below. If, for example, the first alignment film is a polyimide-based alignment film, such an arrangement allows the first alignment film to be placed uniformly on the surface of the heatsink film by virtue of high compatibility between the polyamic acid precursor of the alignment film and the polymerized form (liquid-crystalline polymer) of the liquid-crystalline monomer. As a result, low contrast of the liquid crystal display device is prevented.

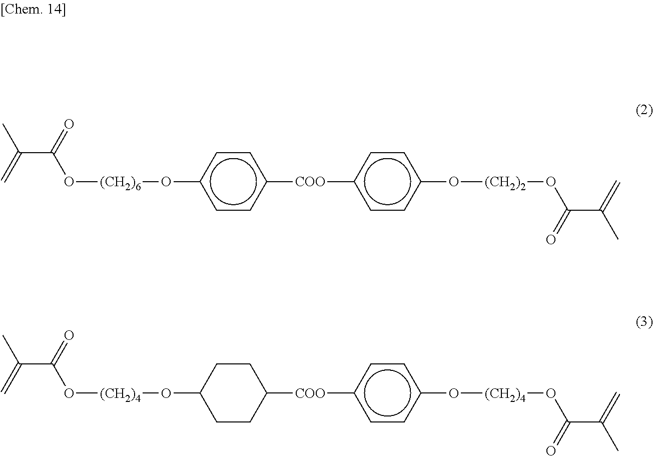

In another aspect of the present invention, the inorganic fine particles may be at least one nitride. In another aspect of the present invention, furthermore, the nitride may include at least one compound selected from the group consisting of boron nitride, silicon nitride, and aluminum nitride. Such an arrangement ensures that the resulting heatsink film will be one in which heat produced by the thin-film transistor element spreads in-plane efficiently.

In another aspect of the present invention, the absolute dielectric anisotropy of the liquid crystal material forming the liquid crystal layer may be 3.0 or less. Such an arrangement enables the production of a liquid crystal display device whose liquid crystal layer will be prevented from undergoing a phase transition while the device is on and that achieves quick response.

In another aspect of the present invention, the electrical resistance of the first alignment film may be 1×10¹⁴ Ω·cm or less. Such an arrangement enables the production of a liquid crystal display device whose liquid crystal layer will be prevented from undergoing a phase transition while the device is on and, if the FFS or other homogeneous alignment mode is used, that is less prone to flicker.

In another aspect of the present invention, the percentage by weight of the inorganic fine particles to the liquid-crystalline monomer may be 10% by weight or more. Such an arrangement ensures heat produced by the thin-film transistor elements will spread in-plane with respect to the heatsink film efficient, thereby enabling the production of a liquid crystal display device whose liquid crystal layer will be fully prevented from undergoing a phase transition while the device is on.

In another aspect of the present invention, the first alignment film may be a photoalignment film, an alignment film having at least one photoreactive functional group. In another aspect of the present invention, furthermore, the photoreactive functional group may include at least one of the azobenzene group and the cinnamate group. Such arrangements will give the liquid crystal display device high contrast.

### REFERENCE SIGNS LIST

1a, 1b: Liquid crystal display device
2: First substrate
3: Heatsink film
4: First alignment film
5: Liquid crystal layer
6: Second alignment film
7: Second substrate
8: Heatsink-film alignment film
10: Support substrate
11: Thin-film transistor element
12: Gate electrode
13: Gate insulating film
14: Semiconductor layer
15: Source electrode
16: Drain electrode
17a, 17b: Interlayer insulating film
18: Pixel electrode
19: Common electrode
20: Inorganic fine particles
21: Liquid-crystalline composition

1. A liquid crystal display device comprising:
a first substrate having a thin-film transistor element;
a heatsink film overlapping the thin-film transistor element;
a first alignment film;
a liquid crystal layer, and
a second substrate in order, wherein:
the heatsink film contains at least one liquid-crystalline polymer as a polymerized form of at least one liquid-crystalline monomer and also contains inorganic fine particles; and
the liquid-crystalline polymer is aligned in-plane with respect to the heatsink film.

2. The liquid crystal display device according to claim 1, wherein there is a heatsink-film alignment film, a film that controls an orientation of the liquid-crystalline polymer, between the first substrate and the heatsink film.

3. The liquid crystal display device according to claim 1, wherein the liquid-crystalline monomer is represented by chemical formula (1) below.
P¹-Sp¹-R¹-A¹-(Z¹-A²)ₙ-R² (1)
(In chemical formula (1) above, R² represents an —R³-Sp²-P² group, hydrogen atom, halogen atom, —CN group, —NO₂ group, —NCO group, —NCS group, —OCN group, —SCN group, —SF₆ group, or linear or branched C1 to C18 alkyl group. P¹ and P² may be the same or different and each represent an acryloyloxy group or methacryloyloxy group. Sp² and Sp² may be the same or different and each represent a linear, branched, or cyclic C1 to C6 alkylene group, linear, branched, or cyclic C1 to C6 alkyleneoxy group, or direct bond. R¹ and R³ may be the same or different and each represent an —O— group, —S— group, —NH— group, —CO— group, —COO— group, —OCO— group, or direct bond. A¹ and A² may be the same or different and each represent a 1,4-phenylene group, naphthalen-2,6-diyl group, or 1,4-cyclohexylene group. Hydrogen atoms A¹ and A² have may be substituted with a fluorine atom, chlorine atom, —CN group, or C1 to C6 alkyl group, alkoxy group, alkylcarbonyl group, alkoxycarbonyl group, or alkylcarbonyloxy group. Z¹ represents an —O— group, —S— group, —NH— group, —CO— group, —COO— group, —OCO— group, or direct bond. n represents 0, 1, 2, or 3.)

4. The liquid crystal display device according to claim 3, wherein the liquid-crystalline monomer includes at least one of monomers represented by chemical formulae (2) and (3) below.

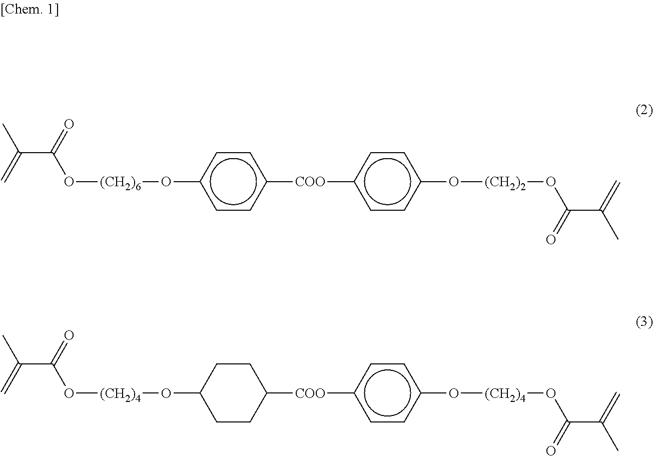

5. The liquid crystal display device according to claim 1, wherein the inorganic fine particles are at least one nitride.

6. The liquid crystal display device according to claim 5, wherein the nitride includes at least one compound selected from the group consisting of boron nitride, silicon nitride, and aluminum nitride.

7. The liquid crystal display device according to claim 1, wherein an absolute dielectric anisotropy of a liquid crystal material forming the liquid crystal layer is 3.0 or less.

8. The liquid crystal display device according to claim 1, wherein an electrical resistance of the first alignment film is 1×10¹⁴ Ω·cm or less.

9. The liquid crystal display device according to claim 1, wherein a percentage by weight of the inorganic fine particles to the liquid-crystalline monomer is 10% by weight or more.

10. The liquid crystal display device according to claim 1, wherein the first alignment film is a photoalignment film, an alignment film having at least one photoreactive functional group.

11. The liquid crystal display device according to claim 10, wherein the photoreactive functional group includes at least one of an azobenzene group and a cinnamate group.

12. A method for producing a liquid crystal display device that includes a first substrate having a thin-film transistor element, a liquid crystal layer, and a second substrate in order, the method comprising:
step (1) as a step of applying a liquid-crystalline composition containing at least one liquid-crystalline monomer and inorganic fine particles to a surface of the first substrate;
step (2) as a step of exposing the liquid-crystalline composition to light to polymerize the liquid-crystalline monomer and thereby to form a heatsink film overlapping the thin-film transistor element; and
step (3) as a step of forming a first alignment film on a surface of the heatsink film, wherein:
the heatsink film contains at least one liquid-crystalline polymer as a polymerized form of the liquid-crystalline monomer and also contains the inorganic fine particles; and
the liquid-crystalline polymer is aligned in-plane with respect to the heatsink film.

13. The method according to claim 12 for producing a liquid crystal display device, further comprising, between steps (2) and (3), step (4) as a step of rubbing the surface of the heatsink film.

14. The method according to claim 12 for producing a liquid crystal display device, further comprising, before step (1), step (5) as a step of forming a heatsink-film alignment film, a film that controls an orientation of the liquid-crystalline polymer, on the surface of the first substrate.

15. The method according to claim 12 for producing a liquid crystal display device, wherein radical polymerization or condensation polymerization of the liquid-crystalline monomer is performed in step (2).

16. The method according to claim 12 for producing a liquid crystal display device, wherein the liquid-crystalline monomer is represented by chemical formula (1) below.
P¹-Sp¹-R¹-A¹-(Z¹-A²)ₙ-R² (1)
(In chemical formula (1) above, R² represents an —R³-Sp²-P² group, hydrogen atom, halogen atom, —CN group, —NO₂ group, —NCO group, —NCS group, —OCN group, —SCN group, —SF₆ group, or linear or branched C1 to C18 alkyl group. P¹ and P² may be the same or different and each represent an acryloyloxy group or methacryloyloxy group. Sp¹ and Sp² may be the same or different and each represent a linear, branched, or cyclic C1 to C6 alkylene group, linear, branched, or cyclic C1 to C6 alkyleneoxy group, or direct bond. R¹ and R³ may be the same or different and each represent an —O— group, —S— group, —NH— group, —CO— group, —COO— group, —OCO— group, or direct bond. A¹ and A² may be the same or different and each represent a 1,4-phenylene group, naphthalen-2,6-diyl group, or 1,4-cyclohexylene group. Hydrogen atoms A¹ and A² have may be substituted with a fluorine atom, chlorine atom, —CN group, or C1 to C6 alkyl group, alkoxy group, alkylcarbonyl group, alkoxycarbonyl group, or alkylcarbonyloxy group. Z¹ represents an —O— group, —S— group, —NH— group, —CO— group, —COO— group, —OCO— group, or direct bond. n represents 0, 1, 2, or 3.)

17. The method according to claim 16 for producing a liquid crystal display device, wherein the liquid-crystalline monomer includes at least one of monomers represented by chemical formulae (2) and (3) below.

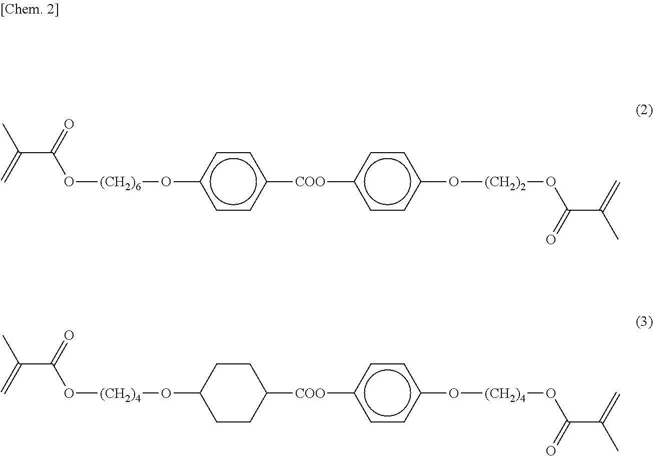

18. The method according to claim 12 for producing a liquid crystal display device, wherein the inorganic fine particles are at least one nitride.

19. The method according to claim 18 for producing a liquid crystal display device, wherein the nitride includes at least one compound selected from the group consisting of boron nitride, silicon nitride, and aluminum nitride.

20. The method according to claim 12 for producing a liquid crystal display device, wherein an absolute dielectric anisotropy of a liquid crystal material forming the liquid crystal layer is 3.0 or less.
